(19) United States
(12) Patent Application Publication
(10) Pub. No.: US 2025/0361171 A1
(43) Pub. Date: Nov. 27, 2025

(54) AU AND AG CONTAINING GLASS COMPOSITION AND COLORED GLASS-BASED ARTICLES FORMED THEREFROM

(71) Applicant: CORNING INCORPORATED, CORNING, NY (US)

(72) Inventors: Erin Katherine Congdon, Canisteo, NY (US); Xiaoju Guo, Pittsford, NY (US); Jesse Kohl, Horseheads, NY (US); Lina Ma, Corning, NY (US)

(21) Appl. No.: 18/873,952

(22) PCT Filed: Jun. 16, 2023
(86) PCT No.: PCT/US2023/025547

§ 371 Date: Dec. 11, 2024

Related U.S. Application Data
(60) Provisional application No. 63/353,238, filed on Jun. 17, 2022.

(51) Int. Cl. C03C 3/085; C03C 4/02

(52) U.S. Cl. CPC C03C 3/085; C03C 4/02; C03C 2201/40; C03C 2203/52

(57) ABSTRACT

A glass composition is provided including greater than or equal to 55 mol % and less than or equal to 68 mol % SiO₂; greater than or equal to 8 mol % to less than or equal to 18 mol % Al₂O₃; greater than or equal to 5 mol % to less than or equal to 15 mol % Li₂O; greater than or equal to 0.0001 mol % to less than or equal to 0.5 mol % Au; and greater than or equal to 0.001 mol % to less than or equal to 1 mol % Ag. The glass composition may be used to produce a glass-based article. The glass-based article may be colored.

### CROSS-REFERENCE TO RELATED APPLICATIONS

This application claims the benefit of priority under 35 U.S.C. § 119 of U.S. Provisional Application Ser. No. 63/353,238 filed on Jun. 17, 2022, the content of which is relied upon and incorporated herein by reference in its entirety.

### FIELD

The present specification generally relates to glass compositions and glass articles and, in particular, to glass compositions that are fusion formable and ion-exchangeable, colored glass articles formed therefrom.

### TECHNICAL BACKGROUND

Aluminosilicate glass articles may exhibit superior ion-exchangeability and drop performance. Various industries, including the consumer electronics industry, desire colored materials with the same or similar strength and fracture toughness properties. However, simply including colorants in conventional aluminosilicate glass compositions may not produce the desired color.

Accordingly, a need exists for alternative colored glass articles having high strength and fracture toughness.

### SUMMARY

According to an aspect, a glass composition is provided. The glass composition comprises: greater than or equal to 55 mol % to less than or equal to 68 mol % SiO₂; greater than or equal to 8 mol % to less than or equal to 18 mol % Al₂O₃; greater than or equal to 5 mol % to less than or equal to 15 mol % Li₂O; greater than or equal to 0.0001 mol % to less than or equal to 0.5 mol % Au; and greater than or equal to 0.001 mol % to less than or equal to 1 mol % Ag.

According to another aspect, a glass composition is provided. The glass composition comprises: greater than or equal to 55 mol % to less than or equal to 76 mol % SiO₂; greater than or equal to 8 mol % to less than or equal to 18 mol % Al₂O₃; greater than or equal to 0.1 mol % to less than or equal to 10 mol % Na₂O; greater than 0 mol % to less than or equal to 4 mol % K₂O; greater than 0 mol % to less than or equal to 3 mol % ZrO₂; greater than 0 ppm to less than or equal to 30 ppm Au; and greater than 0 ppm to less than or equal to 2000 ppm Ag.

According to another aspect, a colored glass-based article is provided. The glass-based article comprises the glass composition of a preceding aspect.

According to another aspect, a colored glass-based article provided. The colored glass-based article comprising: greater than 0 ppm to less than or equal to 30 ppm Au; and greater than 0 ppm to less than or equal to 2000 ppm Ag, wherein the colored glass-based article has a transmittance color coordinate in the CIELAB color space, as measured under F2 illumination and a 100 standard observer angle, of: L* greater than or equal to 50 and less than or equal to 98; a* greater than or equal to −5 and less than or equal to 20; and b* greater than or equal to 15 and less than or equal to 105.

According to another aspect, a method of forming a glass-based article is provided. The method comprises heating a glass composition to form a glass-based article, the glass composition comprising the glass composition of a preceding aspect; and subjecting the glass-based article to a heat treatment cycle at a temperature greater than or equal to 500° C. and less than or equal to 800° C. for a duration greater than or equal to 0.25 hour and less than or equal to 24 hours to produce a colored glass-based article.

Additional features and advantages of the colored glass articles described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a plan view of an electronic device incorporating any of the colored glass articles according to one or more embodiments described herein;

FIG. 2 is a perspective view of the electronic device of FIG. 1;

FIG. 3 is a photograph of colored glass articles with various compositions and heat treatments according to embodiments;

FIG. 4 is a photograph of colored glass articles with various compositions and heat treatments according to embodiments;

FIG. 5 is a photograph of colored glass articles with various compositions after heat treatment according to embodiments;

FIG. 6 is a photograph of colored glass articles with various compositions after heat treatment according to embodiments;

FIG. 7 is a plot of a* (x-axis) vs. b* (y-axis), as measured under F2 illumination and a 100 standard observer angle, of colored glass articles after heat treatment according to embodiments;

FIG. 8 is a plot of a* (x-axis) vs. b* (y-axis), as measured under F2 illumination and a 10° standard observer angle, of colored glass articles after various heat treatments according to embodiments;

FIG. 9 is an FSM image of an ion exchanged colored glass article according to embodiments;

FIG. 10 is an FSM image of an ion exchanged colored glass article according to embodiments;

FIG. 11 is an FSM image of an ion exchanged colored glass article according to embodiments;

FIG. 12 is an FSM image of an ion exchanged colored glass article according to embodiments;

FIG. 13 is an FSM image of an ion exchanged colored glass article according to embodiments; and

FIG. 14 is an FSM image of an ion exchanged colored glass article according to embodiments.

### DETAILED DESCRIPTION

Reference will now be made in detail to various embodiments of glass compositions and colored glass articles formed therefrom having a desired color. According to embodiments, a glass composition includes greater than or equal to 55 mol % to less than or equal to 68 mol % SiO₂; greater than or equal to 8 mol % to less than or equal to 18 mol % Al₂O₃; greater than or equal to 5 mol % to less than or equal to 15 mol % Li₂O; greater than or equal to 0.0001 mol % to less than or equal to 0.5 mol % Au; and greater than or equal to 0.001 mol % to less than or equal to 1 mol % Ag.

In other embodiments, a glass composition includes greater than or equal to 55 mol % to less than or equal to 76 mol % SiO₂; greater than or equal to 8 mol % to less than or equal to 18 mol % Al₂O₃; greater than or equal to 0.1 mol % to less than or equal to 10 mol % Na₂O; greater than 0 mol % to less than or equal to 4 mol % K₂O; greater than 0 mol % to less than or equal to 3 mol % ZrO₂; greater than 0 ppm to less than or equal to 30 ppm Au; and greater than 0 ppm to less than or equal to 2000 ppm Ag.

In some embodiments, a colored glass-based article includes greater than 0 ppm to less than or equal to 30 ppm Au; and greater than 0 ppm to less than or equal to 2000 ppm Ag, wherein the colored glass-based article has a transmittance color coordinate in the CIELAB color space, as measured under F2 illumination and a 100 standard observer angle, of: L* greater than or equal to 50 and less than or equal to 98; a* greater than or equal to −5 and less than or equal to 20; and b* greater than or equal to 15 and less than or equal to 105.

In other embodiments, a method of forming a glass-based article includes heating a glass composition to form a glass-based article, the glass composition including: greater than or equal to 55 mol % to less than or equal to 76 mol % SiO₂; greater than or equal to 8 mol % to less than or equal to 18 mol % Al₂O₃; greater than or equal to 0.1 mol % to less than or equal to 10 mol % Na₂O; greater than 0 mol % to less than or equal to 4 mol % K₂O; greater than 0 mol % to less than or equal to 3 mol % ZrO₂; greater than 0 ppm to less than or equal to 30 ppm Au; and greater than 0 ppm to less than or equal to 2000 ppm Ag; and subjecting the glass-based article to a heat treatment cycle at a temperature greater than or equal to 500° C. and less than or equal to 800° C. for a duration greater than or equal to 0.25 hour and less than or equal to 24 hours to produce a colored glass-based article.

Various embodiments of colored glass articles and methods of making the same will be described herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

In the embodiments of the glass compositions and the resultant colored glass articles described herein, the concentrations of constituent components in oxide form (e.g., SiO₂, Al₂O₃, and the like) are specified in mole percent (mol %) on an oxide basis, unless otherwise specified.

In embodiments of the glass compositions and the resultant colored glass articles described herein, the concentration of Au, Ag, and Pt is specified in mole percent (mol %) and parts per million (ppm), unless otherwise specified. “Mol %” refers to the concentration of respective atoms in the glass composition in any form. “Ppm” refers to the number of units of mass of the respective constituent component per million units of total mass of the glass composition.

The term “substantially free,” when used to describe the concentration and/or absence of a particular constituent component in a glass composition and the resultant colored glass article, means that the constituent component is not intentionally added to the glass composition and the resultant colored glass article. However, the glass composition and the resultant colored glass article may contain traces of the constituent component as a contaminant or tramp in amounts of less than 0.1 mol %.

The terms “0 mol %” and “free,” when used to describe the concentration and/or absence of a particular constituent component in a glass composition and the resultant colored glass article, means that the constituent component is not present in glass composition and the resultant colored glass article.

Surface compressive stress is measured with a surface stress meter (FSM) such as commercially available instruments such as the FSM-6000, manufactured by Orihara Industrial Co., Ltd. (Japan). Surface stress measurements rely upon the measurement of the stress optical coefficient (SOC), which is related to the birefringence of the glass article. SOC, in turn, is measured according to Procedure C (Glass Disc Method) described in ASTM standard C770-16, entitled “Standard Test Method for Measurement of Glass Stress-Optical Coefficient,” the contents of which are incorporated herein by reference in their entirety. Depth of compression (DOC) is also measured with the FSM. The maximum central tension (CT) values are measured using a scattered light polariscope (SCALP) technique known in the art.

The term “depth of compression” (DOC), as used herein, refers to the position in the article where compressive stress transitions to tensile stress.

The term “CIELAB color space,” as used herein, refers to a color space defined by the International Commission on Illumination (CIE) in 1976. It expresses color as three values: L* for the lightness from black (0) to white (100), a* from green (−) to red (+), and b* from blue (−) to yellow (+).

The term “color gamut,” as used herein, refers to the pallet of colors that may be achieved by the colored glass articles within the CIELAB color space.

Colorants may be added to aluminosilicate glass compositions to achieve a colored glass article having a desired color and improved mechanical properties. For example, gold (Au) and silver (Ag) doped glass-based articles of the type described herein may appear orange, among other colors.

Disclosed herein are glass compositions and colored glass-based articles formed therefrom that allow the addition of Au and Ag to aluminosilicate glass compositions to produce colored glass-based articles having the desired color while being suitable for use in mobile electronic device applications. Specifically, the concentration of certain constituent components may be adjusted to achieve a desired color. The term “glass-based article” as utilized herein refers to an article made wholly or partially of glass, and may include glass, glass-ceramic, and glass laminate materials. For the sake of convenience, it should be understood that where a glass article is referred to herein a glass-based article is also disclosed.

The glass compositions and colored glass articles described herein may be described as alkali aluminosilicate glass compositions and colored glass-based articles and comprise SiO₂, Al₂O₃, and Li₂O. In addition to SiO₂, Al₂O₃, and Li₂O, the glass compositions and colored glass articles described herein include Au and Ag to produce colored glass articles having the desired color. For example, the combination of Au and Ag may help to produce colored glass articles have a relatively high b* value (e.g., greater than or equal to 15, as measured under F2 illumination and a 10° standard observer angle). The inclusion of alkali oxides, such as Li₂O, Na₂O, and K₂O, in the glass compositions enable the ion-exchangeability of the colored glass articles.

SiO₂ is the primary glass former in the glass compositions described herein and may function to stabilize the network structure of the colored glass articles. The concentration of SiO₂ in the glass compositions and resultant colored glass articles should be sufficiently high to enhance the chemical durability of the glass composition and, in particular, the resistance of the glass composition to degradation upon exposure to acidic solutions, basic solutions, and in water. The amount of SiO₂ may be limited to control the melting point of the glass composition, as the melting point of pure SiO₂ or high SiO₂ glasses is undesirably high. Thus, limiting the concentration of SiO₂ may aid in improving the meltability and the formability of the resultant colored glass article.

In embodiments, the glass composition and the resultant colored glass article may comprise greater than or equal to 55 mol % and less than or equal to 68 mol % SiO₂. In embodiments, the concentration of SiO₂ in the glass composition and the resultant colored glass article may be greater than or equal to 58 mol %, greater than or equal to 60 mol %, greater than or equal to 62 mol %, greater than or equal to 64 mol %, greater than or equal to 66 mol %, or more. In embodiments, the concentration of SiO₂ in the glass composition and the colored resultant glass article may be less than or equal to 68 mol %, less than or equal to 67 mol %, less than or equal to 65 mol %, less than or equal to 63 mol %, less than or equal to 61 mol %, less than or equal to 60 mol %, less than or equal to 58 mol %, less than or equal to 56 mol %, or less.

In embodiments, the concentration of SiO₂ in the glass composition and the resultant colored glass article may be greater than or equal to 55 mol % and less than or equal to 68 mol %, greater than or equal to 56 mol % and less than or equal to 67 mol %, greater than or equal to 57 mol % and less than or equal to 66 mol %, greater than or equal to 58 mol % and less than or equal to 65 mol %, greater than or equal to 59 mol % and less than or equal to 64 mol %, greater than or equal to 60 mol % and less than or equal to 63 mol %, greater than or equal to 61 mol % and less than or equal to 62 mol %, or any and all sub-ranges formed from any of these endpoints.

In embodiments, the glass composition and the resultant colored glass article may comprise greater than or equal to 55 mol % and less than or equal to 76 mol % SiO₂. In embodiments, the concentration of SiO₂ in the glass composition and the colored resultant glass article may be greater than or equal to 55 mol %, greater than or equal to 57 mol %, greater than or equal to 59 mol %, greater than or equal to 61 mol %, or more. In embodiments, the concentration of SiO₂ in the glass composition and the colored resultant glass article may be less than or equal to 76 mol %, less than or equal to 73 mol %, less than or equal to 70 mol %, or even less than or equal to 67 mol %. In embodiments, the concentration of SiO₂ in the glass composition and the resultant colored glass article may be greater than or equal to 55 mol % and less than or equal to 76 mol %, greater than or equal to 57 mol % and less than or equal to 73 mol %, greater than or equal to 59 mol % and less than or equal to 70 mol %, greater than or equal to 62 mol % and less than or equal to 67 mol %, or any and all sub-ranges formed from any of these endpoints.

Like SiO₂, Al₂O₃ may also stabilize the glass network and additionally provides improved mechanical properties and chemical durability to the glass composition and the resultant colored glass article. The amount of Al₂O₃ may also be tailored to control the viscosity of the glass composition. Al₂O₃ may be included such that the resultant glass composition has the desired fracture toughness (e.g., greater than or equal to 0.7 MPa·m^{1/2}). However, if the amount of Al₂O₃ is too high (e.g., greater than 20 mol %), the viscosity of the glass melt may increase, thereby diminishing the formability of the colored glass article.

Accordingly, in embodiments, the glass composition and the resultant colored glass article may comprise greater than or equal to 8 mol % and less than or equal to 18 mol % Al₂O₃. In embodiments, the concentration of Al₂O₃ in the glass composition and the resultant colored glass article may be greater than or equal to 8 mol %, greater than or equal to 9 mol %, greater than or equal to 10 mol %, greater than or equal to 11 mol %, greater than or equal to 12 mol %, greater than or equal to 13 mol %, greater than or equal to 14 mol %, greater than or equal to 15 mol %, greater than or equal to 16 mol %, greater than or equal to 17 mol %, or more. In embodiments, the concentration of Al₂O₃ in the glass composition and the resultant colored glass article may be less than or equal to 18 mol %, less than or equal to 17 mol %, less than or equal to 16 mol %, less than or equal to 15 mol %, less than or equal to 14 mol %, less than or equal to 13 mol %, less than or equal to 12 mol %, less than or equal to 11 mol %, less than or equal to 10 mol %, less than or equal to 9 mol %, or less. In embodiments, the concentration of Al₂O₃ in the glass composition and the resultant colored glass article may be greater than or equal to 8 mol % and less than or equal to 18 mol %, greater than or equal to 9 mol % and less than or equal to 17 mol %, greater than or equal to 10 mol % and less than or equal to 16 mol %, greater than or equal to 11 mol % and less than or equal to 15 mol %, greater than or equal to 12 mol % and less than or equal to 14 mol %, greater than or equal to 8 mol % and less than or equal to 13 mol %, or any and all sub-ranges formed from any of these endpoints.

The glass compositions described herein may include B₂O₃. The inclusion of B₂O₃ helps improve the damage resistance of the resultant colored glass article. In addition, B₂O₃ reduces the formation of non-bridging oxygen, the presence of which may reduce fracture toughness. However, if B₂O₃ is too high (e.g., greater than 10 mol %), the annealing point and strain point may decrease, which increases stress relaxation and reduces the overall strength of the colored glass article.

In embodiments, the glass composition and the resultant colored glass article may comprise greater than or equal to 0 mol % and less than or equal to 10 mol % B₂O₃. In embodiments, the concentration of B₂O₃ in the glass composition and the resultant colored glass article may be greater than or equal to 0 mol %, greater than 0 mol %, greater than or equal to 0.1 mol %, greater than or equal to 1 mol %, greater than or equal to 2 mol %, greater than or equal to 3 mol %, greater than or equal to 4 mol %, greater than or equal to 5 mol %, greater than or equal to 6 mol %, greater than or equal to 7 mol %, greater than or equal to 8 mol %, greater than or equal to 9 mol %, or more. In embodiments, the concentration of B₂O₃ in the glass composition and the resultant colored glass article may be less than or equal to 10 mol %, less than or equal to 9 mol %, less than or equal to 8 mol %, less than or equal to 7 mol %, less than or equal to 6 mol %, less than or equal to 5 mol %, less than or equal to 4 mol %, less than or equal to 3 mol %, less than or equal to 2 mol %, less than or equal to 1 mol %, or less. In embodiments, the concentration of B₂O₃ in the glass composition and the resultant colored glass article may be greater than or equal to 0 mol % and less than or equal to 10 mol %, greater than 0 mol % and less than or equal to 9 mol %, greater than or equal to 0.1 mol % and less than or equal to 8 mol %, greater than or equal to 1 mol % and less than or equal to 7 mol %, greater than or equal to 2 mol % and less than or equal to 6 mol %, greater than or equal to 3 mol % and less than or equal to 5 mol %, greater than or equal to 0 mol % and less than or equal to 4 mol %, or any and all sub-ranges formed from any of these endpoints. In embodiments, the glass composition and the resultant colored glass article may be substantially free or free of B₂O₃.

As described hereinabove, the glass compositions and the resultant colored glass articles contain alkali oxides, such as Li₂O, Na₂O, and K₂O, to enable the ion-exchangeability of the colored glass articles.

Li₂O aids in the ion-exchangeability of the colored glass article and also reduces the softening point of the glass composition, thereby increasing the formability of the colored glass articles. In addition, Li₂O decreases the melting point of the glass composition, which may help improve Au retention. The concentration of Li₂O in the glass compositions and resultant colored glass articles should be sufficiently high to reduce the melting point of the glass composition and achieve the desired maximum central tension following ion-exchange. However, if the amount of Li₂O is too high (e.g., greater than 15 mol %), the liquidus temperature may increase, thereby diminishing the manufacturability of the colored glass article.

In embodiments, the glass composition and the resultant colored glass article may comprise greater than or equal to 5 mol % and less than or equal to 15 mol % Li₂O. In embodiments, the concentration of Li₂O in the glass composition and the resultant colored glass article may be greater than or equal to 5 mol %, greater than or equal to 7 mol %, greater than or equal to 9 mol %, greater than or equal to 11 mol %, greater than or equal to 13 mol %, or more. In embodiments, the concentration of Li₂O in the glass composition and the resultant colored glass article may be less than or equal to 15 mol %, less than or equal to 14 mol %, less than or equal to 13 mol %, less than or equal to 12 mol %, less than or equal to 11 mol %, less than or equal to 10 mol %, less than or equal to 9 mol %, or less. In embodiments, the concentration of Li₂O in the glass composition and the resultant colored glass article may be greater than or equal to 5 mol % and less than or equal to 15 mol %, greater than or equal to 6 mol % and less than or equal to 14 mol %, greater than or equal to 7 mol % and less than or equal to 13 mol %, greater than or equal to 8 mol % and less than or equal to 12 mol %, greater than or equal to 9 mol % and less than or equal to 11 mol %, greater than or equal to 10 mol % and less than or equal to 15 mol %, or any and all sub-ranges formed from any of these endpoints.

In embodiments, the glass composition and the resultant colored glass article may comprise greater than 0 mol % and less than or equal to 20 mol % Li₂O. In embodiments, the concentration of Li₂O in the glass composition and the resultant colored glass article may be greater than or equal to 0 mol %, greater than or equal to 3 mol %, greater than or equal to 5 mol %, greater than or equal to 7 mol %, greater than or equal to 10 mol %, or more. In embodiments, the concentration of Li₂O in the glass composition and the resultant colored glass article may be less than or equal to 20 mol %, less than or equal to 18 mol %, less, than or equal to 16 mol %, less than or equal to 14 mol %, less than or equal to 12 mol %, or less. In embodiments, the concentration of Li₂O in the glass composition and the resultant colored glass article may be greater than or equal to 0 mol % and less than or equal to 20 mol %, greater than or equal to 3 mol % and less than or equal to 18 mol %, greater than or equal to 5 mol % and less than or equal to 16 mol %, greater than or equal to 7 mol % and less than or equal to 14 mol %, greater than or equal to 10 mol % and less than or equal to 12 mol %, or any and all sub-ranges formed from any of these endpoints. In embodiments, the glass composition and the resultant colored glass article may be substantially free or free of Li₂O.

Na₂O improves diffusivity of alkali ions in the glass and thereby reduces ion-exchange time and helps achieve the desired surface compressive stress. Na₂O also improves the formability of the colored glass article. However, if too much Na₂O is added to the glass composition, the melting point may be too low. As such, in embodiments, the concentration of Li₂O present in the glass composition and the resultant colored glass article may be greater than the concentration of Na₂O present in the glass composition and the resultant colored glass article.

In embodiments, the glass composition and the resultant colored glass article may comprise greater than or equal to 0 mol % and less than or equal to 10 mol % Na₂O. In embodiments, the concentration of Na₂O in the glass composition and the resultant colored glass article may be greater than or equal to 0 mol %, greater than 0 mol %, greater than or equal to 0.1 mol %, greater than or equal to 1 mol %, greater than or equal to 2 mol %, greater than or equal to 3 mol %, greater than or equal to 4 mol %, greater than or equal to 5 mol %, greater than or equal to 6 mol %, greater than or equal to 7 mol %, greater than or equal to 8 mol %, greater than or equal to 9 mol %, or more. In embodiments, the concentration of Na₂O in the glass composition and the resultant colored glass article may be less than or equal to 10 mol %, less than or equal to 9 mol %, less than or equal to 8 mol %, less than or equal to 7 mol %, less than or equal to 6 mol %, less than or equal to 5 mol %, less than or equal to 4 mol %, less than or equal to 3 mol %, less than or equal to 2 mol %, less than or equal to 1 mol %, or less. In embodiments, the concentration of Na₂O in the glass composition and the resultant colored glass article may be greater than or equal to 0 mol % and less than or equal to 10 mol %, greater than or equal to 0.1 mol % and less than or equal to 9 mol %, greater than or equal to 1 mol % and less than or equal to 8 mol %, greater than or equal to 2 mol % and less than or equal to 7 mol %, greater than or equal to 3 mol % and less than or equal to 6 mol %, greater than or equal to 4 mol % and less than or equal to 5 mol %, or any and all sub-ranges formed from any of these endpoints.

K₂O promotes ion-exchange and may increase the depth of compression and decrease the melting point to improve the formability of the colored glass article. However, adding too much K₂O may cause the surface compressive stress and melting point to be too low. Accordingly, in embodiments, the amount of K₂O added to the glass composition may be limited.

In embodiments, the glass composition and the resultant colored glass article may comprise greater than or equal to 0 mol % and less than or equal to 4 mol % K₂O. In embodiments, the concentration of K₂O in the glass composition and the resultant colored glass article may be greater than or equal to 0 mol %, greater than 0 mol %, greater than or equal to 0.1 mol %, greater than or equal to 1 mol %, greater than or equal to 2 mol %, greater than or equal to 3 mol %, or more. In embodiments, the concentration of K₂O in the glass composition and the resultant colored glass article may be less than or equal to 4 mol %, less than or equal to 3 mol %, less than or equal to 2 mol %, less than or equal to 1 mol %, less than or equal to 0.5 mol %, less than or equal to 0.25 mol %, or less. In embodiments, the concentration of K₂O in the glass composition and the resultant colored glass article may be greater than or equal to 0 mol % and less than or equal to 4 mol %, greater than or equal to 0.1 mol % and less than or equal to 3 mol %, greater than or equal to 0.2 mol % and less than or equal to 2 mol %, greater than or equal to 0.5 mol % and less than or equal to 1 mol %, greater than or equal to 0 mol % and less than or equal to 0.5 mol %, greater than 0.1 mol % and less than or equal to 0.25 mol %, or any and all sub-ranges formed from any of these endpoints. In embodiments, the glass composition and the resultant colored glass article may be substantially free or free of K₂O.

As used herein, “R₂O” refers to the sum of Li₂O, Na₂O, and K₂O (i.e., Li₂O (mol %)+Na₂O (mol %)+K₂O (mol %)) in the glass composition and the resultant colored glass article. “RO” refers to the sum of MgO, ZnO, CaO, BaO, and SrO (i.e., MgO (mol %)+ZnO (mol %)+CaO (mol %)+BaO (mol %)+SrO (mol %)) in the glass composition and the resultant colored glass article.

In embodiments, Al₂O₃—R₂O—RO in the glass composition and the resultant colored glass article may be less than or equal to 0 mol %, such as less than or equal to −0.5 mol %, less than or equal to −1 mol %, or even less than or equal to −3 mol %.

In embodiments, (Al₂O₃+B₂O₃)−(R₂O+RO) in the glass composition and the resultant colored glass article may be greater than or equal to −10 mol % to ensure that the glass composition and the resulted colored glass article achieve a desired b* value (e.g., greater than or equal to 15, as measured under F2 illumination and a 10° standard observer angle). In embodiments, (Al₂O₃+B₂O₃)−(R₂O+RO) in the glass composition and the resultant colored glass article may be limited (e.g., less than or equal to 5) to ensure that Ag contributes to the coloring of the glass article. Accordingly, in embodiments, (Al₂O₃+B₂O₃)−(R₂O+RO) in the glass composition and the resultant colored glass article may be greater than or equal to −10 mol % and less than or equal to 5 mol %, such as greater than or equal to −5 mol % and less than or equal to 3 mol %, greater than or equal to −3 mol % and less than or equal to 1 mol %, or any and all sub-ranges formed from any of these endpoints.

The glass compositions and the resultant colored glass articles described herein may further comprise P₂O₅. The inclusion of P₂O₅ may improve the ion exchange efficiency of the glass composition. In embodiments, the glass composition and the resultant colored glass article may comprise greater than or equal to 0 mol % and less than or equal to 3 mol % P₂O₅, such as greater than or equal to 0.1 mol % and less than or equal to 2 mol %, greater than or equal to 0.5 mol % and less than or equal to 1 mol %, or any and all sub-ranges formed from any of these endpoints. In embodiments, the glass composition and the resultant colored glass article may be substantially free or free of P₂O₅.

The glass compositions and the resultant colored glass articles described herein may further comprise Fe₂O₃. Fe₂O₃ may also act as a colorant in addition to Au. In embodiments, the glass composition and the resultant colored glass article may comprise greater than or equal to 0 mol % and less than or equal to 1 mol % Fe₂O₃, such as greater than or equal to 0.01 mol % and less than or equal to 0.1 mol %. In embodiments, the glass composition and the resultant colored glass article may be substantially free or free of Fe₂O₃.

The glass compositions and the resultant colored glass articles described herein may further comprise one or more fining agents. In embodiments, the fining agents may include, for example, SnO₂. In embodiments, the glass composition and the resultant colored glass article may comprise greater than or equal to 0 mol % and less than or equal to 1 mol % SnO₂, such as greater than or equal to 0.01 mol % and less than or equal to 0.1 mol %. In embodiments, the glass composition and the resultant colored glass article may be substantially free or free of SnO₂.

In embodiments, the glass composition and the resultant colored glass article may include alkaline earth oxides, such as MgO, CaO, SrO, and BaO, and may also include ZnO.

In embodiments, the concentration of MgO in the glass composition and the resultant colored glass article may be greater than or equal to 0 mol % and less than or equal to 8 mol %. In embodiments, the concentration of MgO in the glass composition and the resultant colored glass article may be greater than or equal to 0 mol % and less than or equal to 8 mol %, greater than or equal to 1 mol % and less than or equal to 7 mol %, greater than or equal to 2 mol % and less than or equal to 6 mol %, greater than or equal to 3 mol % and less than or equal to 5 mol %, greater than or equal to 0.1 mol % and less than or equal to 4 mol %, or any and all sub-ranges formed from any of these endpoints. In embodiments, the glass composition and the resultant colored glass article may be substantially free or free of MgO.

In embodiments, the concentration of CaO in the glass composition and the resultant colored glass article may be greater than or equal to 0 mol % and less than or equal to 6 mol %. In embodiments, the concentration of CaO in the glass composition and the resultant colored glass article may be greater than or equal to 0 mol % and less than or equal to 6 mol %, greater than or equal to 1 mol % and less than or equal to 5 mol %, greater than or equal to 2 mol % and less than or equal to 4 mol %, greater than or equal to 0 mol % and less than or equal to 3 mol %, or any and all sub-ranges formed from any of these endpoints. In embodiments, the glass composition and the resultant colored glass article may be substantially free or free of CaO.

In embodiments, the concentration of ZnO in the glass composition and the resultant colored glass article may be greater than or equal to 0 mol % and less than or equal to 3 mol %. In embodiments, the concentration of ZnO in the glass composition and the resultant colored glass article may be greater than or equal to 0 mol % and less than or equal to 3 mol %, greater than or equal to 1 mol % and less than or equal to 2 mol %, or any and all sub-ranges formed from any of these endpoints. In embodiments, the glass composition and the resultant colored glass article may be substantially free or free of ZnO.

In embodiments, the concentration of BaO in the glass composition and the resultant colored glass article may be greater than or equal to 0 mol % and less than or equal to 1 mol %. In embodiments, the concentration of BaO in the glass composition and the resultant colored glass article may be greater than or equal to 0 mol % and less than or equal to 1 mol %, greater than or equal to 0.1 mol % and less than or equal to 0.5 mol %, or any and all sub-ranges formed from any of these endpoints. In embodiments, the glass composition and the resultant colored glass article may be substantially free or free of BaO.

In embodiments, the concentration of SrO in the glass composition and the resultant colored glass article may be greater than or equal to 0 mol % and less than or equal to 1 mol %. In embodiments, the concentration of SrO in the glass composition and the resultant colored glass article may be greater than or equal to 0 mol % and less than or equal to 1 mol %, greater than or equal to 0.1 mol % and less than or equal to 0.5 mol %, or any and all sub-ranges formed from any of these endpoints. In embodiments, the glass composition and the resultant colored glass article may be substantially free or free of SrO.

In embodiments, the concentration of ZrO₂ in the glass composition and the resultant colored glass article may be greater than or equal to 0 mol % and less than or equal to 1.5 mol %. In embodiments, the concentration of ZrO₂ in the glass composition and the resultant colored glass article may be greater than or equal to 0 mol % and less than or equal to 1.5 mol %, greater than or equal to 0.1 mol % and less than or equal to 1 mol %, or any and all sub-ranges formed from any of these endpoints. In embodiments, the glass composition and the resultant colored glass article may be substantially free or free of ZrO₂.

In embodiments, the concentration of ZrO₂ in the glass composition and the resultant colored glass article may be greater than 0 mol % and less than or equal to 3 mol %. In embodiments, the concentration of ZrO₂ in the glass composition and the resultant colored glass article may be greater than 0 mol % and less than or equal to 3 mol %, greater than or equal to 0.01 mol % and less than or equal to 2 mol %, greater than or equal to 0.05 mol % and less than or equal to 1 mol %, greater than or equal to 0.1 mol % and less than or equal to 0.5 mol %, or any and all sub-ranges formed from any of these endpoints.

In embodiments, the concentration of TiO₂ in the glass composition and the resultant colored glass article may be greater than or equal to 0 mol % and less than or equal to 1 mol %. In embodiments, the concentration of TiO₂ in the glass composition and the resultant colored glass article may be greater than or equal to 0 mol % and less than or equal to 1 mol %, greater than or equal to 0.1 mol % and less than or equal to 0.5 mol %, or any and all sub-ranges formed from any of these endpoints. In embodiments, the glass composition and the resultant colored glass article may be substantially free or free of TiO₂.

In embodiments, the concentration of La₂O₃ in the glass composition and the resultant colored glass article may be greater than or equal to 0 mol % and less than or equal to 0.5 mol %. In embodiments, the concentration of La₂O₃ in the glass composition and the resultant colored glass article may be greater than or equal to 0 mol % and less than or equal to 0.5 mol %, greater than or equal to 0.01 mol % and less than or equal to 0.1 mol %, or any and all sub-ranges formed from any of these endpoints. In embodiments, the glass composition and the resultant colored glass article may be substantially free or free of La₂O₃.

In embodiments, the concentration of Y₂O₃ in the glass composition and the resultant colored glass article may be greater than or equal to 0 mol % and less than or equal to 0.5 mol %. In embodiments, the concentration of Y₂O₃ in the glass composition and the resultant colored glass article may be greater than or equal to 0 mol % and less than or equal to 0.5 mol %, greater than or equal to 0.01 mol % and less than or equal to 0.1 mol %, or any and all sub-ranges formed from any of these endpoints. In embodiments, the glass composition and the resultant colored glass article may be substantially free or free of Y₂O₃.

In embodiments, the concentration of Bi₂O₃ in the glass composition and the resultant colored glass article may be greater than or equal to 0 mol % and less than or equal to 0.5 mol %. In embodiments, the concentration of Bi₂O₃ in the glass composition and the resultant colored glass article may be greater than or equal to 0 mol % and less than or equal to 0.5 mol %, greater than or equal to 0.01 mol % and less than or equal to 0.1 mol %, or any and all sub-ranges formed from any of these endpoints. In embodiments, the glass composition and the resultant colored glass article may be substantially free or free of Bi₂O₃.

The glass compositions and the resultant colored glass articles described herein include Au as a colorant to achieve the desired color. In embodiments, the glass composition and the resultant colored glass article may include Au in a concentration greater than or equal to 0.0001 mol % to greater than or equal to 0.5 mol %, such as greater than or equal to 0.0001 mol % and less than or equal to 0.1 mol % Au. In embodiments, the concentration of Au in the glass composition and the resultant colored glass article may be greater than or equal to 0.0001 mol %, greater than or equal to 0.0002 mol %, greater than or equal to 0.0003 mol %, greater than or equal to 0.0004 mol %, greater than or equal to 0.0005 mol %, greater than or equal to 0.0006 mol %, greater than or equal to 0.0007 mol %, greater than or equal to 0.0008 mol %, greater than or equal to 0.0009 mol %, greater than or equal to 0.001 mol %, greater than or equal to 0.002 mol %, greater than or equal to 0.003 mol %, greater than or equal to 0.004 mol %, greater than or equal to 0.005 mol %, greater than or equal to 0.006 mol %, greater than or equal to 0.007 mol %, greater than or equal to 0.008 mol %, greater than or equal to 0.009 mol %, greater than or equal to 0.01 mol %, or more. In embodiments, the concentration of Au in the glass composition and the resultant colored glass article may be less than or equal to 0.5 mol %, less than or equal to 0.1 mol %, less than or equal to 0.01 mol %, less than or equal to 0.009 mol %, less than or equal to 0.008 mol %, less than or equal to 0.007 mol %, less than or equal to 0.006 mol %, less than or equal to 0.005 mol %, less than or equal to 0.004 mol %, less than or equal to 0.003 mol %, less than or equal to 0.002 mol %, less than or equal to 0.001 mol %, less than or equal to 0.0009 mol %, less than or equal to 0.0008 mol %, less than or equal to 0.0007 mol %, less than or equal to 0.0006 mol %, less than or equal to 0.0005 mol %, less than or equal to 0.0004 mol %, less than or equal to 0.0003 mol %, or less. In embodiments, the concentration of Au in the glass composition and the resultant colored glass article may be greater than or equal to 0.0001 mol % and less than or equal to 0.5 mol %, greater than or equal to 0.0001 mol % and less than or equal to 0.1 mol %, greater than or equal to 0.0002 mol % and less than or equal to 0.09 mol %, greater than or equal to 0.0003 mol % and less than or equal to 0.08 mol %, greater than or equal to 0.0003 mol % and less than or equal to 0.07 mol %, greater than or equal to 0.0004 mol % and less than or equal to 0.06 mol %, greater than or equal to 0.0005 mol % and less than or equal to 0.05 mol %, greater than or equal to 0.0006 mol % and less than or equal to 0.04 mol %, greater than or equal to 0.0007 mol % and less than or equal to 0.03 mol %, greater than or equal to 0.0008 mol % and less than or equal to 0.02 mol %, greater than or equal to 0.0009 mol % and less than or equal to 0.01 mol %, greater than or equal to 0.001 mol % and less than or equal to 0.009 mol %, greater than or equal to 0.002 mol % and less than or equal to 0.008 mol %, greater than or equal to 0.003 mol % and less than or equal to 0.007 mol %, greater than or equal to 0.004 mol % and less than or equal to 0.006 mol %, greater than or equal to 0.001 mol % and less than or equal to 0.005 mol %, or any and all sub-ranges formed from any of these endpoints.

In embodiments, the amount of Au in the glass composition and the resultant colored glass article may be greater than 0 ppm and less than or equal to 30 ppm. In embodiments, the concentration of Au in the glass composition and the resultant colored glass article may be greater than 0 ppm, greater than or equal to 0.5 ppm, greater than or equal to 1 ppm, greater than or equal to 3 ppm, or more. In embodiments, the concentration of Au in the glass composition and the resultant colored glass article may be less than or equal to 30 ppm, less than or equal to 20 ppm, less than or equal to 10 ppm, less than or equal to 5 ppm, or less. In embodiments, the concentration of Au in the glass composition and the resultant colored glass article may be greater than 0 ppm and less than or equal to 30 ppm, greater than or equal to 0.5 ppm and less than or equal to 20 ppm, greater than or equal to 1 ppm and less than or equal to 10 ppm, greater than or equal to 3 ppm and less than or equal to 5 ppm, or any and all sub-ranges formed from any of these endpoints.

The glass compositions and the resultant colored glass articles described herein include Ag as an additional colorant to achieve the desired color. In embodiments, the glass composition and the resultant colored glass article may include Ag in a concentration greater than or equal to 0.001 mol % and less than or equal to 1 mol %, such as greater than or equal to 0.001 mol % and less than or equal to 0.1 mol %. In embodiments, the concentration of Ag in the glass composition and the resultant colored glass article may be greater than or equal to 0.001 mol %, greater than or equal to 0.01 mol %, greater than or equal to 0.02 mol %, greater than or equal to 0.03 mol %, greater than or equal to 0.04 mol %, greater than or equal to 0.05 mol %, greater than or equal to 0.06 mol %, greater than or equal to 0.07 mol %, greater than or equal to 0.08 mol %, greater than or equal to 0.09 mol %, greater than or equal to 0.10 mol %, greater than or equal to 0.11 mol %, greater than or equal to 0.12 mol %, greater than or equal to 0.13 mol %, greater than or equal to 0.14 mol %, greater than or equal to 0.15 mol %, greater than or equal to 0.16 mol %, greater than or equal to 0.17 mol %, greater than or equal to 0.18 mol %, greater than or equal to 0.19 mol %, or more. In embodiments, the concentration of Ag in the glass composition and the resultant colored glass article may be less than or equal to 1 mol %, less than or equal to 0.1 mol %, less than or equal to 0.09 mol %, less than or equal to 0.08 mol %, less than or equal to 0.07 mol %, less than or equal to 0.06 mol %, less than or equal to 0.05 mol %, less than or equal to 0.04 mol %, less than or equal to 0.03 mol %, less than or equal to 0.01 mol %, or less. In embodiments, the concentration of Ag in the glass composition and the resultant colored glass article may be greater than or equal to 0.001 mol % and less than or equal to 1 mol %, greater than or equal to 0.001 mol % and less than or equal to 0.1 mol %, greater than or equal to 0.01 mol % and less than or equal to 0.09 mol %, greater than or equal to 0.02 mol % and less than or equal to 0.08 mol %, greater than or equal to 0.03 mol % and less than or equal to 0.07 mol %, greater than or equal to 0.04 mol % and less than or equal to 0.06 mol %, greater than or equal to 0.01 mol % and less than or equal to 0.05 mol %, or any and all sub-ranges formed from any of these endpoints.

In embodiments, the amount of Ag in the glass composition and the resultant colored glass article may be greater than 0 ppm and less than or equal to 2000 ppm. In embodiments, the concentration of Ag in the glass composition and the resultant colored glass article may be greater than 0 ppm, greater than or equal to 50 ppm, greater than or equal to 100 ppm, greater than or equal to 200 ppm, or more. In embodiments, the concentration of Ag in the glass composition and the resultant colored glass article may be less than or equal to 2000 ppm, less than or equal to 1500 ppm, less than or equal to 1000 ppm, less than or equal to 500 ppm, or less. In embodiments, the concentration of Ag in the glass composition and the resultant colored glass article may be greater than 0 ppm and less than or equal to 2000 ppm, greater than or equal to 50 ppm and less than or equal to 1500 ppm, greater than or equal to 100 ppm and less than or equal to 1000 ppm, greater than or equal to 200 ppm and less than or equal to 2000 ppm, or any and all sub-ranges formed from any of these endpoints.

In embodiments, the glass compositions and the resultant colored glass articles described herein may further include tramp materials such as MoO₃, WO₃, CdO, As₂O₃, sulfur-based compounds, such as sulfates, halogens, or combinations thereof. In embodiments, the glass composition and the resultant colored glass article may be substantially free or free of tramp materials such as MoO₃, WO₃, CdO, As₂O₃, sulfur-based compounds, such as sulfates, halogens, or combinations thereof. In embodiments, antimicrobial components, chemical fining agents, or other additional components may be included in the glass compositions and the resultant colored glass articles.

In embodiments, a glass composition may comprise: greater than or equal to 55 mol % to less than or equal to 68 mol % SiO₂; greater than or equal to 8 mol % to less than or equal to 18 mol % Al₂O₃; greater than or equal to 5 mol % to less than or equal to 15 mol % Li₂O; greater than or equal to 0.0001 mol % to less than or equal to 0.5 mol % Au; and greater than or equal to 0.001 mol % to less than or equal to 1 mol % Ag.

In embodiments, a glass composition may comprise: greater than or equal to 55 mol % to less than or equal to 76 mol % SiO₂; greater than or equal to 8 mol % to less than or equal to 18 mol % Al₂O₃; greater than or equal to 0.1 mol % to less than or equal to 10 mol % Na₂O; greater than 0 mol % to less than or equal to 4 mol % K₂O; greater than 0 mol % to less than or equal to 3 mol % ZrO₂; greater than 0 ppm to less than or equal to 30 ppm Au; and greater than 0 ppm to less than or equal to 2000 ppm Ag.

In embodiments, the colored glass article may have a transmittance color coordinate in the CIELAB color space, as measured under F2 illumination and a 100 standard observer angle, of: L* greater than or equal to 50 and less than or equal to 98; a* greater than or equal to −5 and less than or equal to 30; and b* greater than or equal to −25 and less than or equal to 45. In embodiments, the colored glass article may have a transmittance color coordinate in the CIELAB color space, as measured under F2 illumination and a 10° standard observer angle, of L* greater than or equal to 50 and less than or equal to 98, such as greater than or equal to 52 and less than or equal to 96, greater than or equal to 55 and less than or equal to 97, greater than or equal to 60 and less than or equal to 95, greater than or equal to 65 and less than or equal to 94, greater than or equal to 75 and less than or equal to 93, greater than or equal to 80 and less than or equal to 92, greater than or equal to 85 and less than or equal to 91, greater than or equal to 70 and less than or equal to 90, or any and all sub-ranges formed from any of these endpoints. In embodiments, the colored glass article may have a transmittance color coordinate in the CIELAB color space, as measured under F2 illumination and a 100 standard observer angle, of a* greater than or equal to −5 and less than or equal to 30, such as greater than or equal to −1 and less than or equal to 28, greater than or equal to −4 and less than or equal to 20, greater than or equal to −3 and less than or equal to 15, greater than or equal to −2 and less than or equal to 10, greater than or equal to −1 and less than or equal to 5, or any and all sub-ranges formed from any of these endpoints. In embodiments, the colored glass article may have a transmittance color coordinate in the CIELAB color space, as measured under F2 illumination and a 10° standard observer angle, of b* greater than or equal to −25 and less than or equal to 45, such as greater than or equal to −21 and less than or equal to 41, greater than or equal to −15 and less than or equal to 40, greater than or equal to −10 and less than or equal to 45, greater than or equal to −5 and less than or equal to 40, greater than or equal to 0 and less than or equal to 35, greater than or equal to 5 and less than or equal to 30, greater than or equal to 10 and less than or equal to 25, greater than or equal to −20 and less than or equal to 20, or any and all sub-ranges formed from any of these endpoints.

In particular, the combination of Au (e.g., greater than 0 ppm and less than or equal to 30 ppm) and Ag (e.g., greater than 0 ppm and less than 2000 ppm) in the glass composition and the resultant glass article may help to achieve colored glass articles having a relatively high b* value (e.g., greater than or equal to 15, as measured under F2 illumination and a 10° standard observer angle) such that the colored glass article is visibly yellow in color. In embodiments, the colored glass article may have a transmittance color coordinate in the CIELAB color space, as measured under F2 illumination and a 10° standard observer angle, of: L* greater than or equal to 50 and less than or equal to 98; a* greater than or equal to −5 and less than or equal to 20; and b* greater than or equal to 15 and less than or equal to 105.

In embodiments, the colored glass-based article has a transmittance color coordinate in the CIELAB color space, as measured under F2 illumination and a 100 standard observer angle, of b* greater than or equal to 15 and less than or equal to 105. In embodiments, the colored glass-based article has a transmittance color coordinate in the CIELAB color space, as measured under F2 illumination and a 100 standard observer angle, of b* greater than or equal to 15, greater than or equal to 25, greater than or equal to 35, greater than or equal to 45, greater than or equal to 55, greater than or equal to 65, or more. In embodiments, the colored glass-based article has a transmittance color coordinate in the CIELAB color space, as measured under F2 illumination and a 10° standard observer angle, of b* less than or equal to 105, less than or equal to 95, less than or equal to 85, less than or equal to 75, or less. In embodiments, the colored glass-based article has a transmittance color coordinate in the CIELAB color space, as measured under F2 illumination and a 10° standard observer angle, of b* greater than or equal to 15 and less than or equal to 105, greater than or equal to 25 and less than or equal to 95, greater than or equal to 35 and less than or equal to 85, greater than or equal to 45 and less than or equal to 75, greater than or equal to 55 and less than or equal to 105, greater than or equal to 65 and less than or equal to 95, or any and all sub-ranges formed from any of these endpoints.

In embodiments, the colored glass-based article has a transmittance color coordinate in the CIELAB color space, as measured under F2 illumination and a 100 standard observer angle, of a* greater than or equal to −5 and less than or equal to 20. In embodiments, the colored glass-based article has a transmittance color coordinate in the CIELAB color space, as measured under F2 illumination and a 100 standard observer angle, of a* greater than or equal to −5, greater than or equal to −3, greater than or equal to −1, greater than or equal to 1, greater than or equal to 3, greater than or equal to 5, or more. In embodiments, the colored glass-based article has a transmittance color coordinate in the CIELAB color space, as measured under F2 illumination and a 100 standard observer angle, of a* less than or equal to 20, less than or equal to 15, less than or equal to 10, less than or equal to 5 or less. In embodiments, the colored glass-based article has a transmittance color coordinate in the CIELAB color space, as measured under F2 illumination and a 100 standard observer angle, of a* greater than or equal to −5 and less than or equal to 20, greater than or equal to −3 and less than or equal to 15, greater than or equal to −1 and less than or equal to 10, greater than or equal to 1 and less than or equal to 20, greater than or equal to 3 and less than or equal to 15, greater than or equal to 5 and less than or equal to 10, greater than or equal to −5 and less than or equal to 5, or any and all sub-ranges formed from any of these endpoints.

In embodiments, the colored glass-based article has a transmittance color coordinate in the CIELAB color space, as measured under F2 illumination and a 100 standard observer angle, of L* greater than or equal to 50 and less than or equal to 98. In embodiments, the colored glass-based article has a transmittance color coordinate in the CIELAB color space, of L* greater than or equal to 50, greater than or equal to 60, greater than or equal to 70, greater than or equal to 80, or more. In embodiments, the colored glass-based article has a transmittance color coordinate in the CIELAB color space, of L* less than or equal to 98, less than or equal to 95, less than or equal to 90, less than or equal to 85, or less. In embodiments, the colored glass-based article has a transmittance color coordinate in the CIELAB color space, of L* greater than or equal to 50 and less than or equal to 98, greater than or equal to 60 and less than or equal to 95, greater than or equal to 70 and less than or equal to 90, greater than or equal to 80 and less than or equal to 85, or any and all sub-ranges formed from any of these endpoints.

Different color coordinates within the color gamut may be achieved by altering the heat treatment cycle used to produce the resultant colored glass articles. The heat treatment cycle is characterized by the temperature of the environment (i.e., the oven) and the duration of the cycle (i.e., the time the glass article is exposed to the heated environment). As used herein, the phrase “temperature of the heat treatment cycle” refers to the temperature of the environment (i.e., the oven). In embodiments, glass articles formed from the glass compositions described herein are heat treated in an isothermal oven to produce the resultant colored glass articles.

In embodiments, the temperature of the heat treatment cycle may be greater than or equal to 500° C., greater than or equal to 550° C., greater than or equal to 575° C., greater than or equal to 600° C., greater than or equal to 625° C., greater than or equal to 650° C., greater than or equal to 675° C., greater than or equal to 700° C., greater than or equal to 725° C., greater than or equal to 750° C., greater than or equal to 775° C., or more. In embodiments, the temperature of the heat treatment cycle may be less than or equal to 800° C., less than or equal to 775° C., less than or equal to 750° C., less than or equal to 725° C., less than or equal to 700° C., less than or equal to 675° C., less than or equal to 650° C., less than or equal to 625° C., less than or equal to 600° C., less than or equal to 575° C., less than or equal to 550° C., less than or equal to 525° C., or less. In embodiments, the temperature of the heat treatment cycle may be greater than or equal to 500° C. and less than or equal to 800° C., greater than or equal to 525° C. and less than or equal to 775° C., greater than or equal to 550° C. and less than or equal to 750° C., greater than or equal to 575° C. and less than or equal to 725° C., greater than or equal to 600° C. and less than or equal to 700° C., greater than or equal to 625° C. and less than or equal to 675° C., greater than or equal to 500° C. and less than or equal to 650° C., or any and all sub-ranges formed from any of these endpoints.

In embodiments, the duration of the heat treatment cycle may be greater than or equal to 0.25 hour, greater than or equal to 0.5 hour, greater than or equal 1 hour, greater than or equal to 2 hours, greater than or equal to 2 hours, greater than or equal to 3 hours, greater than or equal to 4 hours, greater than or equal to 5 hours, greater than or equal to 6 hours, greater than or equal 7 hours, greater than or equal to 8 hours, greater than or equal to 9 hours, greater than or equal to 10 hours, greater than or equal to 12 hours, greater than or equal to 18 hours, or more. In embodiments, the duration of the heat treatment cycle may be less than or equal to 24 hours, less than or equal to 18 hours, less than or equal to 16 hours, less than or equal to 12 hours, less than or equal to 10 hours, less than or equal to 9 hours, less than or equal to 8 hours, less than or equal to 7 hours, less than or equal to 6 hours, less than or equal to 5 hours, less than or equal to 4 hours, less than or equal to 3 hours, less than or equal to 2 hours, less than or equal to 1 hour, less than or equal to 0.5 hours, or less. In embodiments, the duration of the heat treatment cycle may be greater than or equal to 0.25 hours and less than or equal to 24 hours, greater than or equal to 0.5 hours and less than or equal to 18 hours, greater than or equal to 1 hour and less than or equal to 16 hours, greater than or equal to 2 hours and less than or equal to 12 hours, greater than or equal to 3 hours and less than or equal to 10 hours, greater than or equal to 4 hours and less than or equal to 9 hours, greater than or equal to 5 hours and less than or equal to 8 hours, greater than or equal to 6 hours and less than or equal to 7 hours, or any and all sub-ranges formed from any of these endpoints.

In embodiments, the heat treatment cycle may comprise heating the glass article from room temperature to the heat treatment temperature at a heating rate, holding the glass article at the heat treatment temperature for the duration, and cooling down from the heat treatment temperature to room temperature at a cooling rate. In embodiments, the selected heating rate and cooling down rate may effect the color coordinates of the resultant colored glass articles.

In embodiments, the heating rate of the heat treatment may be greater than or equal to 1° C./min to less than or equal to 10° C./min. In embodiments, the heating rate of the heat treatment may be greater than or equal to 1° C./min, greater than or equal to 2° C./min, or more. In embodiments, the heating rate of the heat treatment may be less than or equal to 10° C./min, less than or equal to 8° C./min, less than or equal to 6° C./min, less than or equal to 4° C./min, or less. In embodiments, the heating rate of the heat treatment may be greater than or equal to 1° C./min and less than or equal to 10° C./min, greater than or equal to 2° C./min and less than or equal to 8° C./min, greater than or equal to 1° C./min and less than or equal to 6° C./min, greater than or equal to 2° C./min and less than or equal to 4° C./min, or any and all sub-ranges formed from any of these endpoints.

In embodiments, the cooling rate of the heat treatment may be greater than or equal to 1° C./min, greater than or equal to 2° C./min, or more. In embodiments, the cooling rate of the heat treatment may be less than or equal to 10° C./min, less than or equal to 8° C./min, less than or equal to 6° C./min, less than or equal to 4° C./min, or less. In embodiments, the cooling rate of the heat treatment may be greater than or equal to 1° C./min and less than or equal to 10° C./min, greater than or equal to 2° C./min and less than or equal to 8° C./min, greater than or equal to 1° C./min and less than or equal to 6° C./min, greater than or equal to 2° C./min and less than or equal to 4° C./min, or any and all sub-ranges formed from any of these endpoints.

In embodiments, the glass compositions and the resultant colored glass articles may have color stability. In particular, in embodiments, when subjected to heat treatment at a given temperature and for a given time, the glass compositions and the resultant colored glass articles may have a delta b* value of less than 1 b* unit/° C.

In embodiments, the glass compositions and the resultant colored glass articles may have thermal stability. In particular, in embodiments, the colored glass-based article may have a delta b* transmittance color coordinate in the CIELAB color space, as measured under F2 illumination and a 100 standard observer angle, of greater than or equal to −1 and less than or equal to 1, when exposed to ultraviolet light for 24 hours.

The colored glass articles formed from the glass compositions described herein may be any suitable thickness, which may vary depending on the particular application of the colored glass article. In embodiments, the colored glass articles may have a thickness greater than or equal to 250 μm and less than or equal to 6 mm, greater than or equal to 300 μm and less than or equal to 5 mm, greater than or equal to 350 μm and less than or equal to 4 mm, greater than or equal to 400 μm and less than or equal to 3.5 mm, greater than or equal to 500 μm and less than or equal to 3 μm, greater than or equal to 550 μm and less than or equal to 2.5 μm, greater than or equal to 600 μm and less than or equal to 2 mm, greater than or equal to 650 μm and less than or equal to 1.5 mm, greater than or equal to 700 μm and less than or equal to 1 mm, greater than or equal to 750 μm and less than or equal to 950 μm, greater than or equal to 800 μm and less than or equal to 900 μm, greater than or equal to 250 μm and less than or equal to 850 μm, or any and all sub-ranges formed from any of these endpoints.

In embodiments, the glass compositions described herein are ion-exchangeable to facilitate strengthening the colored glass article made from the glass compositions. In typical ion-exchange processes, smaller metal ions in the glass compositions are replaced or “exchanged” with larger metal ions of the same valence within a layer that is close to the outer surface of the colored glass article made from the glass composition. The replacement of smaller ions with larger ions creates a compressive stress within the layer of the colored glass article made from the glass composition. In embodiments, the metal ions are monovalent metal ions (e.g., Li⁺, Na⁺, K⁺, and the like), and ion-exchange is accomplished by immersing the glass article made from the glass composition in a bath comprising at least one molten salt of the larger metal ion that is to replace the smaller metal ion in the colored glass article. Alternatively, other monovalent ions such as Ag⁺, Tl⁺, Cu⁺, and the like may be exchanged for monovalent ions. The ion-exchange process or processes that are used to strengthen the colored glass article made from the glass composition may include contacting the colored glass article with an ion-exchange medium. In embodiments, the ion-exchange medium may be a molten salt bath. For example, the ion-exchange process may include, but is not limited to, immersion in a single bath or multiple baths of like or different compositions with optional washing and/or annealing steps between immersions.

Upon exposure to the colored glass article, the ion exchange solution (e.g., KNO₃ and/or NaNO₃ molten salt bath) may, according to embodiments, be at a temperature greater than or equal to 350° C. and less than or equal to 500° C., greater than or equal to 360° C. and less than or equal to 490° C., greater than or equal to 370° C. and less than or equal to 480° C., greater than or equal to 380° C. and less than or equal to 470° C., greater than or equal to 390° C. and less than or equal to 460° C., greater than or equal to 400° C. and less than or equal to 450° C., greater than or equal to 410° C. and less than or equal to 440° C., greater than or equal to 420° C. and less than or equal to 430° C., or any and all sub-ranges between the foregoing values. In embodiments, the colored glass article may be exposed to the ion exchange solution for a duration greater than or equal to 2 hours and less than or equal to 24 hours, greater than or equal to 2 hours and less than or equal to 12 hours, greater than or equal to 3 hours and less than or equal to 11 hours, greater than or equal to 4 hours and less than or equal to 10 hours, greater than or equal to 5 hours and less than or equal to 9 hours, greater than or equal to 6 hours and less than or equal to 8 hours, greater than or equal to 2 hours and less than or equal to 7 hours, or any and all sub-ranges formed from any of these endpoints.

In embodiments, a colored glass article made from a glass composition may be ion-exchanged to achieve a depth of compression greater than or equal to 10 μm, greater than or equal to 20 μm, greater than or equal to 30 μm, greater than or equal to 40 μm, greater than or equal to 50 μm, greater than or equal to 60 μm, greater than or equal to 70 μm, greater than or equal to 80 μm, greater than or equal to 90 μm, greater than or equal to 100 μm, greater than or equal to 110 μm, greater than or equal to 120 μm, greater than or equal to 130 μm, greater than or equal to 140 μm, greater than or equal to 150 μm, or more. In embodiments, the colored glass article made from the glass composition may have a thickness “t” and may be ion-exchanged to achieve a depth of compression greater than or equal to 0.15 t, greater than or equal to 0.16 t, greater than or equal to 0.17 t, greater than or equal to 0.18 t, greater than or equal to 0.19 t, greater than or equal to 0.20 t, greater than or equal to 0.21 t, or more. In embodiments, the colored glass article made from the glass composition described herein may have a thickness “t” and may be ion-exchanged to achieve a depth of compression greater than or equal to 0.15 t and less than or equal to 0.3 t, greater than or equal to 0.16 t and less than or equal to 0.29 t, greater than or equal to 0.17 t and less than or equal to 0.28 t, greater than or equal to 0.18 t and less than or equal to 0.27 t, greater than or equal to 0.19 t and less than or equal to 0.26 t, greater than or equal to 0.20 t and less than or equal to 0.25 t, greater than or equal to 0.21 t and less than or equal to 0.24 t, greater than or equal to 0.22 t and less than or equal to 0.23 t, or any and all sub-ranges formed from any of these endpoints.

The development of this surface compression layer is beneficial for achieving a better crack resistance and higher flexural strength compared to non-ion-exchanged materials. The surface compression layer has a higher concentration of the ions exchanged into the colored glass article in comparison to the concentration of the ions exchanged into the colored glass article for the body (i.e., the area not including the surface compression) of the colored glass article. In embodiments, the colored glass article made from the glass composition may have a surface compressive stress after ion-exchange strengthening greater than or equal to 300 MPa, greater than or equal to 400 MPa, greater than or equal to 500 MPa, greater than or equal to 600 MPa, greater than or equal to 700 MPa, greater than or equal to 800 MPa, greater than or equal to 900 MPa, or more. In embodiments, the colored glass article made from the glass composition may have a surface compressive stress after ion-exchange strengthening less than or equal to 1 GPa, less than or equal to 900 MPa, less than or equal to 800 MPa, less than or equal to 700 MPa, less than or equal to 600 MPa, less than or equal to 500 MPa, less than or equal to 400 MPa, or less. In embodiments, the colored glass article made from the glass composition may have a surface compressive stress after ion-exchange strengthening greater than or equal to 300 MPa and less than or equal to 1 GPa, greater than or equal to 400 MPa and less than or equal to 900 MPa, greater than or equal to 500 MPa and less than or equal to 800 MPa, greater than or equal to 600 MPa and less than or equal to 700 MPa, or any and all sub-ranges formed from any of these endpoints.

In embodiments, the colored glass articles made from the glass composition may have a maximum central tension after ion-exchange strengthening greater than or equal to 40 MPa, greater than or equal to 50 MPa, greater than or equal to 60 MPa, greater than or equal to 70 MPa, greater than or equal to 80 MPa, greater than or equal to 90 MPa, greater than or equal to 100 MPa, or more. In embodiments, the colored glass article made from the glass composition may have a maximum central tension after ion-exchange strengthening less than or equal to 250 MPa, less than or equal to 225 MPa, less than or equal to 200 MPa, less than or equal to 175 MPa, less than or equal to 150 MPa, less than or equal to 125 MPa, less than or equal to 100 MPa, less than or equal to 75 MPa, or less. In embodiments, the colored glass article made from the glass composition may have a maximum central tension after ion-exchange strengthening greater than or equal to 40 MPa and less than or equal to 250 MPa, greater than or equal to 50 MPa and less than or equal to 225 MPa, greater than or equal to 60 MPa and less than or equal to 200 MPa, greater than or equal to 70 MPa and less than or equal to 175 MPa, greater than or equal to 80 MPa and less than or equal to 150 MPa, greater than or equal to 90 MPa and less than or equal to 125 MPa, greater than or equal to 100 MPa and less than or equal to 250 MPa, or any and all sub-ranges formed from any of these endpoints. As utilized herein, central tension refers to a maximum central tension value unless otherwise indicated.

In embodiments, a ratio of compressive stress to central tension of the colored glass article made from the glass composition, after ion-exchange strengthening, may be from 2:1 to 10:1, from 2:1 to 8:1, from 4:1 to 10:1, from 4:1 to 8:1, from 6:1 to 10:1, or even from 6:1 to 8:1, or any and all sub-ranges formed from any of these endpoints.

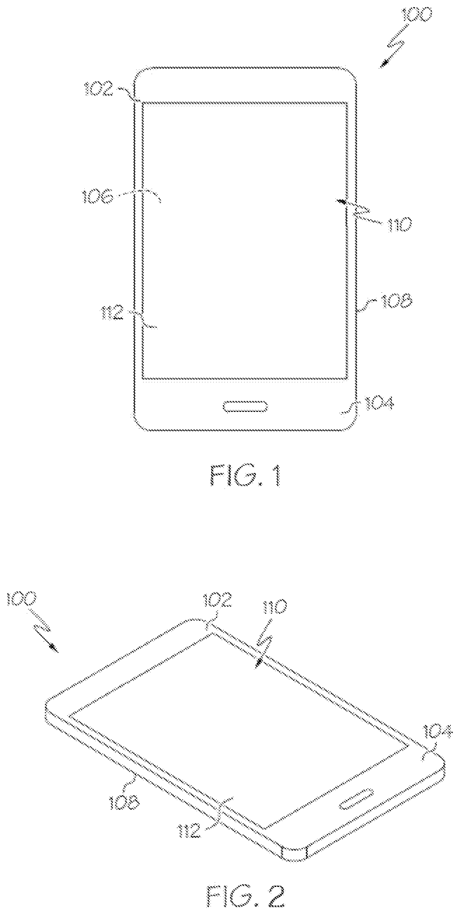

The colored glass articles described herein may be used for a variety of applications including, for example, back cover applications in consumer or commercial electronic devices such as smartphones, tablet computers, personal computers, ultrabooks, televisions, and cameras. An exemplary article incorporating any of the colored glass articles disclosed herein is shown in FIGS. 1 and 2. Specifically, FIGS. 1 and 2 show a consumer electronic device 100 including a housing 102 having front 104, back 106, and side surfaces 108; electrical components (not shown) that are at least partially inside or entirely within the housing and including at least a controller, a memory, and a display 110 at or adjacent to the front surface of the housing; and a cover substrate 112 at or over the front surface of the housing such that it is over the display. In embodiments, at least a portion of housing 102, such as the back 106, may include any of the colored glass articles disclosed herein.

### Examples

In order that various embodiments be more readily understood, reference is made to the following examples, which illustrate various embodiments of the glass compositions and glass-based articles described herein.

Examples with glass compositions as shown in Table I were batched and then roll formed to produce glass articles. The concentrations in Table I are reported in mol %, and the analyzed Au and Ag concentrations indicate the measured Au and Ag content after the forming process.

TABLE I

| Example | 1 | 2 | 3 | 4 | 5 | 6 | 7 |
|---|---|---|---|---|---|---|---|
| SiO₂ | 61.8 | 61.8 | 61.8 | 61.8 | 61.8 | 61.8 | 61.8 |
| Al₂O₃ | 15 | 15 | 15 | 15 | 15 | 15 | 15 |
| B₂O₃ | 6 | 6 | 6 | 6 | 6 | 6 | 6 |
| Li₂O | 9 | 9 | 9 | 9 | 9 | 9 | 9 |
| Na₂O | 2 | 2 | 2 | 2 | 2 | 2 | 2 |
| K₂O | 0.2 | 0.2 | 0.2 | 0.2 | 0.2 | 0.2 | 0.2 |
| MgO | 3 | 3 | 3 | 3 | 3 | 3 | 3 |
| ZnO | 1 | 1 | 1 | 1 | 1 | 1 | 1 |
| CaO | 2 | 2 | 2 | 2 | 2 | 2 | 2 |
| SnO₂ | 0.04 | 0.04 | 0.04 | 0.04 | 0.04 | 0.04 | 0.04 |
| Fe₂O₃ | 0.05 | 0.05 | 0.05 | 0.05 | 0.05 | 0.05 | 0.05 |
| ZrO₂ | 0.3 | 0.3 | 0.3 | 0.3 | 0.3 | 0.3 | 0.3 |
| Au | 0.0015 | 0.0015 | 0.0015 | 0.0010 | 0.0010 | 0.0010 | 0.0015 |
| Ag | 0.03 | 0.06 | 0.10 | 0.03 | 0.06 | 0.10 | 0.03 |
| Au | | | | | | | |
| (Analyzed) | | | | | | | |
| Ag | | | | | | | |
| (Analyzed) | | | | | | | |

| Example | 8 | 9 | 10 | 11 | 12 |
|---|---|---|---|---|---|
| SiO₂ | 61.8 | 61.8 | 61.8 | 61.8 | 61.8 |
| Al₂O₃ | 15 | 15 | 15 | 15 | 15 |
| B₂O₃ | 6 | 6 | 6 | 6 | 6 |
| Li₂O | 9 | 9 | 9 | 9 | 9 |
| Na₂O | 2 | 2 | 2 | 2 | 2 |
| K₂O | 0.2 | 0.2 | 0.2 | 0.2 | 0.2 |
| MgO | 3 | 3 | 3 | 3 | 3 |
| ZnO | 1 | 1 | 1 | 1 | 1 |
| CaO | 2 | 2 | 2 | 2 | 2 |
| SnO₂ | 0.04 | 0.04 | 0.04 | 0.04 | 0.04 |
| Fe₂O₃ | 0.05 | 0.05 | 0.05 | 0.05 | 0.05 |
| ZrO₂ | 0.3 | 0.3 | 0.3 | 0.3 | 0.3 |
| Au | 0.0015 | 0.0015 | 0.0023 | 0.0023 | 0.0023 |
| Ag | 0.06 | 0.10 | 0.06 | 0.06 | 0.04 |
| Au | | | 0.0007 | 0.0008 | 0.00098 |
| (Analyzed) | | | | | |
| Ag | | | 0.0676 | 0.0797 | 0.0584 |
| (Analyzed) | | | | | |

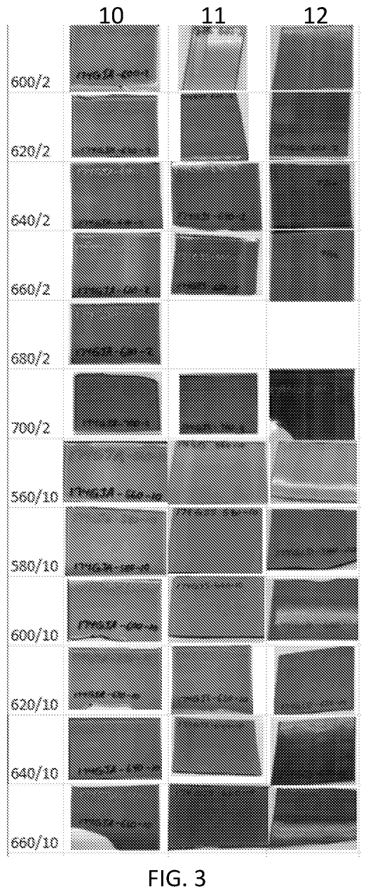

Articles with the composition of Examples 10, 11, and 12 were subjected to heat treatment at multiple time and temperature conditions. The color capability of the glass was significantly expanded by including Ag along with the Au. The colored glass articles are shown in FIG. 3, with the Example composition along the top of figure and the temperature (° C.)/time (minutes) down the left side of the figure.

Additional examples were produced with compositions as shown in Table II.

TABLE II

| Example | 13 | 14 | 15 |
|---|---|---|---|
| SiO₂ | 60.7 | 60.7 | 60.7 |
| Al₂O₃ | 14.5 | 14.5 | 14.5 |
| B₂O₃ | 6 | 6 | 6 |
| Li₂O | 10 | 10 | 10 |
| Na₂O | 4.5 | 4.5 | 4.5 |
| K₂O | 0.2 | 0.2 | 0.2 |
| SnO₂ | 0.01 | 0.01 | 0.01 |
| Ag | 0.005 | 0.050 | 0.100 |
| MgO | 3 | 3 | 3 |
| ZnO | 1 | 1 | 1 |
| ZrO₂ | 0.2 | 0.2 | 0.2 |
| Fe₂O₃ | 0.1 | 0.1 | 0.1 |
| Au | 0.005 | 0.005 | 0.005 |

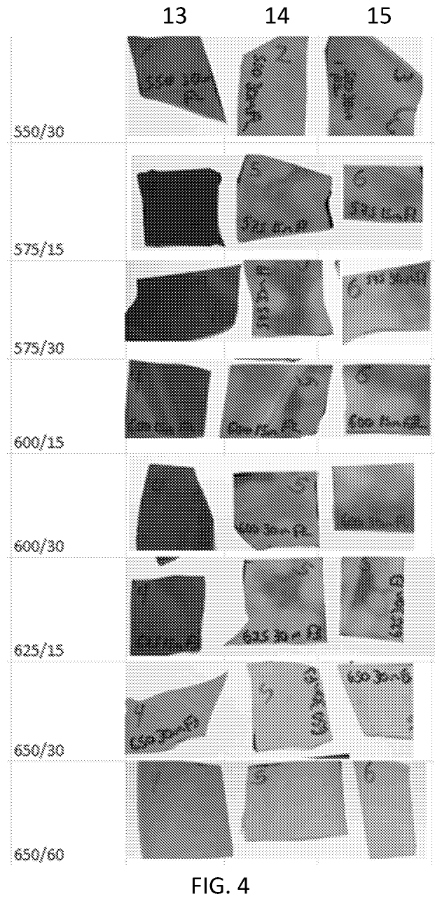

Articles with the composition of Examples 13, 14, and 15 were subjected to heat treatment at multiple time and temperature conditions. The orange color was stable over a range of about 50° C. The colored glass articles are shown in FIG. 4, with the Example composition along the top of figure and the temperature (° C.)/time (minutes) down the left side of the figure.

Color measurements, as described herein, were taken for Examples 10, 11, and 12 for various heat treatment (HT) conditions. The heat treatment conditions and measured color values are reported in Table III.

TABLE III

| | Example | | | | | | | | |
|---|---|---|---|---|---|---|---|---|---|
| HT Condition | 10 | | | 11 | | | 12 | | |
| (° C./hr) | L* | a* | b* | L* | a* | b* | L* | a* | b* |
| 540/2 | 96.16 | −0.28 | 0.9 | 96.1 | −0.31 | 1.03 | 96.35 | −0.25 | 1.02 |
| 560/2 | 95.31 | 0.22 | 1.63 | 96.04 | −0.29 | 1.05 | 96.21 | −0.22 | 0.98 |
| 580/2 | 93.67 | 2.02 | 2.56 | 94.22 | 1.32 | 2.28 | 95 | 0.69 | 1.56 |
| 600/2 | 81.84 | 16.78 | 11.87 | 86.69 | 10.26 | 5.95 | 79.07 | 17.11 | 2.27 |
| 620/2 | 77.58 | 21.53 | 12.67 | 73.65 | 25.03 | 15.21 | 64.92 | 23.69 | −6.73 |
| 640/2 | 66.44 | 24.04 | −5.8 | 62.81 | 27.85 | −2.31 | 60.34 | 5.98 | −16.47 |
| 660/2 | 65.12 | −0.81 | −14.57 | 55.69 | 3.1 | −19.89 | 67.44 | −0.96 | −7.45 |
| 680/2 | 63.59 | 15.46 | −10.6 | | | | | | |
| 700/2 | 70.14 | 19.84 | 12.61 | 63.67 | 25.15 | 16.35 | | | |
| 540/10 | 95.72 | −0.1 | 1.35 | 96.09 | −0.3 | 1.11 | 95.96 | −0.2 | 1.21 |
| 560/10 | 87.07 | 10.36 | 8.76 | 83.73 | 13.77 | 9.27 | 90.01 | 6.27 | 3.76 |
| 580/10 | 83.7 | 12.41 | 29.48 | 79.42 | 17.92 | 31.78 | 76.05 | 23.22 | 20.06 |
| 600/10 | 82.6 | 13.61 | 33.86 | 78.62 | 18.08 | 37.35 | 73.13 | 25.14 | 19.1 |
| 620/10 | 82.46 | 13.61 | 35.9 | 77.74 | 18.74 | 40.8 | 69.47 | 26.63 | 7.51 |
| 640/10 | 74.3 | 22.45 | 17.9 | 71.72 | 23.95 | 34.58 | 54.22 | 13.66 | −20.88 |
| 660/10 | 64.07 | 20.68 | 6.96 | 56.66 | 26.4 | 5.5 | 52.5 | 10.29 | −18.85 |

Example glass composition 16A is shown in Table IV. The concentrations in Table IV are reported in mol %, except for Au, which is provided in ppm, and refer to the batched concentration. Table V shows the CIELAB color space of 2.4 mm thick glass articles formed from example glass compositions 16A-16I after heat treatment. The heat treatment included heating the glass article from room temperature to 580° C. at a heating rate of 2° C./min, holding the glass articles at 580° C. for 6 hours, then cooling the glass article to room temperature. Example glass compositions 16B-16I were glass compositions that started with example glass composition 16A as the base composition and had modifications thereto as listed in Table V. “Glass Article Sample” refers to a glass article having the glass composition listed in the corresponding left-hand column.

TABLE IV

| Example | 16A |
|---|---|
| SiO₂ | 63.491 |
| Al₂O₃ | 14.666 |
| B₂O₃ | 4.678 |
| Li₂O | 10.081 |
| Na₂O | 5.328 |
| K₂O | 0.558 |
| MgO | 0.100 |
| CaO | 0.747 |
| ZnO | 0.011 |
| SnO₂ | 0.123 |
| TiO₂ | 0.008 |
| ZrO₂ | 0.205 |
| Fe₂O₃ | 0.004 |
| Au (ppm) | 30 |

TABLE V

| | Glass Article | | | |
|---|---|---|---|---|
| Example | Sample | L* | a* | b* |
| 16A | 1 | 86.22 | 6.20 | 10.90 |
| | 2 | 85.65 | 6.59 | 11.43 |
| | 3 | 84.49 | 7.49 | 13.08 |
| | 4 | 84.78 | 7.09 | 12.33 |
| | 5 | 83.95 | 7.76 | 13.65 |
| | 6 | 84.29 | 7.21 | 13.06 |
| | 7 | 83.64 | 7.80 | 14.38 |
| | 8 | 84.37 | 7.07 | 12.80 |
| | 9 | 84.04 | 7.19 | 13.51 |
| | 10 | 83.82 | 7.35 | 13.40 |
| | 11 | 83.93 | 7.35 | 13.37 |
| | 12 | 83.85 | 7.26 | 13.64 |
| | 13 | 83.83 | 7.34 | 13.41 |
| | 14 | 83.39 | 7.53 | 13.86 |
| | 15 | 83.42 | 7.46 | 13.77 |
| | 16 | 83.34 | 7.57 | 13.55 |
| | 17 | 83.59 | 7.36 | 13.66 |
| | 18 | 83.45 | 7.44 | 13.78 |
| | 19 | 83.14 | 7.71 | 13.84 |
| | 20 | 83.16 | 7.88 | 13.61 |
| | 21 | 83.30 | 7.77 | 13.71 |
| | 22 | 83.26 | 7.83 | 13.26 |
| | 23 | 83.14 | 7.95 | 13.22 |
| | 24 | 83.10 | 7.98 | 13.32 |
| | 25 | 83.01 | 8.13 | 13.16 |
| | 26 | 82.92 | 8.02 | 13.58 |
| | 27 | 82.98 | 7.93 | 13.52 |
| 16B | 1 | 96.65 | −0.04 | 0.35 |
| (Decreased Au to | 2 | 91.90 | 3.18 | 2.80 |
| about 27-28 ppm) | 3 | 91.15 | 3.75 | 4.09 |
| | 4 | 90.33 | 4.12 | 4.89 |
| | 5 | 90.05 | 4.33 | 5.33 |
| | 6 | 89.96 | 4.31 | 5.58 |
| | 7 | 89.57 | 4.37 | 5.99 |
| | 8 | 89.71 | 4.46 | 5.90 |
| | 9 | 89.70 | 4.55 | 5.70 |
| | 10 | 89.80 | 4.54 | 5.80 |
| | 11 | 89.56 | 4.51 | 6.29 |
| | 12 | 89.15 | 4.95 | 6.85 |
| | 13 | 89.56 | 4.37 | 6.46 |
| | 14 | 89.35 | 4.72 | 6.30 |
| | 15 | 89.22 | 4.57 | 6.71 |
| | 16 | 89.20 | 4.84 | 6.89 |
| | 17 | 89.07 | 4.78 | 7.06 |
| | 18 | 88.62 | 4.95 | 7.93 |
| | 19 | 89.52 | 4.46 | 6.45 |
| | 20 | 88.70 | 4.94 | 7.47 |
| | 21 | 88.52 | 5.25 | 8.05 |
| | 22 | 88.53 | 5.21 | 7.67 |
| | 23 | 87.84 | 5.39 | 9.16 |
| | 24 | 87.91 | 5.31 | 8.40 |
| | 25 | 87.63 | 5.48 | 9.24 |
| | 26 | 87.52 | 5.36 | 9.43 |
| | 27 | 86.84 | 5.56 | 10.93 |
| | 28 | 86.89 | 5.88 | 10.02 |
| | 29 | 86.42 | 6.42 | 10.84 |
| | 30 | 86.44 | 6.02 | 10.59 |
| | 31 | 85.81 | 6.65 | 11.66 |
| 16C | 1 | 83.15 | 7.72 | 13.80 |
| (Increased SnO₂ | 2 | 83.36 | 7.47 | 13.83 |
| concentration to | 3 | 83.31 | 7.38 | 14.03 |
| 0.3 mol %) | 4 | 83.24 | 7.31 | 14.32 |
| 16D | 1 | 83.02 | 7.55 | 14.15 |
| (Decreased Au to | 2 | 82.85 | 7.27 | 14.74 |
| 20 ppm and | 3 | 82.96 | 7.41 | 14.61 |
| increased SnO₂ | 4 | 82.36 | 7.53 | 14.46 |
| concentration to | 5 | 82.46 | 7.76 | 14.47 |
| 0.2 mol %) | 6 | 82.10 | 7.66 | 14.68 |
| | 7 | 81.93 | 7.80 | 14.02 |
| | 8 | 81.63 | 7.99 | 14.07 |
| | 9 | 81.68 | 7.80 | 14.37 |
| | 10 | 82.57 | 7.73 | 14.81 |
| | 11 | 83.82 | 7.15 | 13.32 |
| | 12 | 82.77 | 7.75 | 14.48 |
| | 13 | 83.37 | 7.59 | 13.66 |
| | 14 | 83.54 | 7.57 | 13.05 |
| | 15 | 83.52 | 7.60 | 12.97 |
| | 16 | 82.41 | 8.50 | 13.61 |
| | 17 | 82.61 | 8.49 | 13.05 |
| | 18 | 82.85 | 8.38 | 12.56 |
| | 19 | 83.31 | 7.96 | 12.54 |
| | 20 | 83.62 | 7.78 | 11.72 |
| | 21 | 83.04 | 8.27 | 10.74 |
| | 22 | 82.84 | 8.46 | 9.47 |
| | 23 | 82.85 | 8.51 | 8.90 |
| 16E | 1 | 82.15 | 8.93 | 8.64 |
| (Replaced 0.7 | 2 | 81.59 | 9.19 | 7.72 |
| mol % CaO with | 3 | 82.09 | 8.84 | 6.94 |
| ZnO) | 4 | 81.48 | 9.14 | 6.52 |
| | 5 | 81.60 | 8.88 | 6.09 |
| | 6 | 81.40 | 8.82 | 5.25 |
| | 7 | 81.20 | 8.87 | 4.33 |
| | 8 | 81.10 | 8.81 | 3.92 |
| | 9 | 81.46 | 8.82 | 3.70 |
| | 10 | 81.39 | 8.42 | 3.88 |
| 16F | 1 | 81.21 | 7.77 | 2.53 |
| (Increased Fe₂O₃ | 2 | 81.44 | 8.11 | 2.52 |
| to 0.05 mol %) | 3 | 81.29 | 7.49 | 2.37 |
| | 4 | 81.44 | 7.46 | 2.45 |
| | 5 | 82.35 | 7.84 | 3.47 |
| | 6 | 84.74 | 7.34 | 6.84 |
| | 7 | 85.81 | 6.90 | 7.74 |
| | 8 | 86.03 | 6.63 | 8.35 |
| | 9 | 86.33 | 6.35 | 8.09 |
| | 10 | 86.12 | 6.51 | 8.20 |
| | 11 | 86.32 | 6.42 | 8.06 |
| | 12 | 86.09 | 6.42 | 8.07 |
| | 13 | 86.20 | 6.28 | 8.01 |
| | 14 | 86.26 | 6.36 | 8.15 |
| 16G | 1 | 86.55 | 6.46 | 8.34 |
| (Decreased Fe₂O₃ | 2 | 87.01 | 6.40 | 8.10 |
| to 0 mol % and | 3 | 86.72 | 6.85 | 8.05 |
| decreased SnO₂ to | 4 | 86.32 | 7.37 | 7.55 |
| 0.005 mol %) | 5 | 86.04 | 7.92 | 6.90 |
| | 6 | 85.97 | 8.47 | 6.29 |
| | 7 | 86.10 | 8.39 | 6.10 |
| | 8 | 85.67 | 8.73 | 5.61 |
| | 9 | 85.68 | 8.57 | 5.62 |
| | 10 | 85.43 | 8.89 | 5.12 |
| | 11 | 85.64 | 8.57 | 5.36 |
| | 12 | 85.56 | 8.55 | 5.25 |
| | 13 | 85.41 | 8.61 | 5.18 |
| | 14 | 85.62 | 8.52 | 5.09 |
| | 15 | 85.59 | 8.49 | 5.05 |
| | 16 | 85.43 | 8.28 | 5.14 |
| | 17 | 85.59 | 8.18 | 5.07 |
| 16H | 1 | 87.62 | 7.90 | 13.84 |
| (Added 1000 ppm | 2 | 87.85 | 7.06 | 22.47 |
| Ag) | 3 | 86.48 | 2.85 | 59.26 |
| | 4 | 86.04 | 2.30 | 71.00 |
| | 5 | 84.29 | 3.83 | 68.81 |
| | 6 | 83.30 | 4.58 | 69.09 |
| | 7 | 82.75 | 4.77 | 71.05 |
| | 8 | 82.34 | 5.01 | 72.08 |
| | 9 | 81.91 | 5.36 | 71.90 |
| | 10 | 82.17 | 5.20 | 71.44 |
| | 11 | 82.19 | 5.33 | 70.04 |
| | 12 | 81.65 | 5.91 | 68.32 |
| | 13 | 81.92 | 5.90 | 66.11 |
| | 14 | 81.61 | 5.86 | 69.20 |
| | 15 | 81.39 | 5.95 | 70.60 |
| 16I | 1 | 81.96 | 5.65 | 68.40 |
| (Added 150 ppm | 2 | 82.21 | 5.32 | 70.05 |
| Ag and removed | 3 | 83.23 | 4.64 | 68.55 |
| Au) | 4 | 83.74 | 4.19 | 69.57 |
| | 5 | 83.39 | 4.18 | 71.01 |
| | 6 | 84.63 | 3.58 | 67.89 |
| | 7 | 86.14 | 2.23 | 69.19 |
| | 8 | 86.65 | 2.13 | 67.28 |
| | 9 | 86.97 | 2.06 | 66.51 |
| | 10 | 86.90 | 2.04 | 66.94 |
| | 11 | 86.99 | 2.21 | 65.67 |
| | 12 | 87.05 | 2.47 | 63.41 |
| | 13 | 87.69 | 1.71 | 65.61 |
| | 14 | 87.44 | 2.00 | 64.46 |
| | 15 | 87.78 | 2.20 | 60.40 |
| | 16 | 87.94 | 2.35 | 58.05 |
| | 17 | 88.27 | 2.12 | 58.45 |
| | 18 | 88.21 | 2.41 | 56.53 |
| | 19 | 88.03 | 3.24 | 50.39 |
| | 20 | 87.91 | 3.11 | 51.61 |
| | 21 | 88.30 | 2.51 | 55.20 |
| | 22 | 87.27 | 3.01 | 59.81 |
| | 23 | 88.20 | 2.68 | 54.02 |
| | 24 | 88.47 | 2.27 | 55.64 |
| | 25 | 88.19 | 2.42 | 56.51 |
| | 26 | 88.42 | 2.54 | 54.39 |
| | 27 | 88.37 | 2.77 | 53.66 |
| | 28 | 88.43 | 2.97 | 51.07 |
| | 29 | 88.16 | 2.92 | 51.97 |
| | 30 | 88.19 | 3.28 | 48.79 |
| | 31 | 87.98 | 3.24 | 48.70 |
| | 32 | 87.74 | 2.73 | 47.29 |
| | 33 | 88.38 | 3.26 | 37.39 |
| | 34 | 88.95 | 3.31 | 32.95 |
| | 35 | 89.36 | 3.19 | 32.10 |
| | 36 | 89.63 | 4.17 | 23.12 |
| | 37 | 90.38 | 3.91 | 20.32 |
| | 38 | 91.42 | 1.51 | 31.13 |
| | 39 | 92.37 | 1.23 | 25.42 |
| | 40 | 93.49 | −0.18 | 23.78 |
| | 41 | 94.18 | 0.58 | 14.93 |
| | 42 | 94.77 | 0.15 | 11.93 |
| | 43 | 94.98 | −0.47 | 12.41 |
| | 44 | 95.46 | −0.41 | 08.20 |
| | 45 | 95.83 | −0.40 | 06.14 |
| | 46 | 91.94 | −2.74 | 52.78 |
| | 47 | 92.60 | −3.27 | 49.27 |
| | 48 | 93.08 | −3.83 | 46.36 |
| | 49 | 93.91 | −3.37 | 35.74 |
| | 50 | 94.46 | −2.71 | 26.86 |
| | 51 | 94.58 | −3.03 | 26.56 |
| | 52 | 94.93 | −1.90 | 18.01 |
| | 53 | 95.38 | −1.40 | 13.19 |

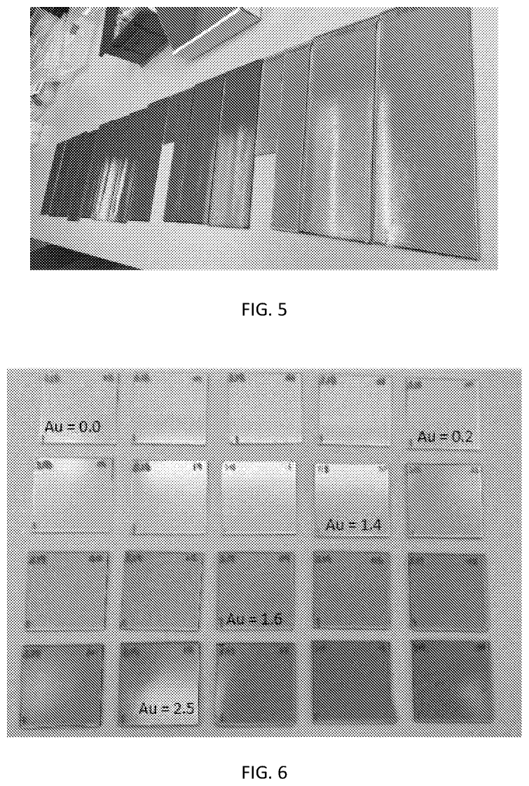

Referring now to FIG. 5, a photograph of glass articles after heat treatment, with brown articles shown on the left side of the image, orange articles shown in the middle of the image, and yellow articles shown on the right side of the image. As exemplified by Tables IV and V and FIG. 5, glass compositions including Au and Ag may be used to form glass articles having a b* greater than or equal to 15.

Example glass composition 17 and properties thereof are shown in Table VI. The concentrations in Table VI are reported in mol %, except for Au and Ag, which are provided in ppm. The concentrations of each component listed in Table VI are provided in ranges to account for experimental variation.

TABLE VI

| Example | 17 |
|---|---|
| SiO₂ | 62-65 |
| Al₂O₃ | 14-15.3 |
| B₂O₃ | 3.7-4.8 |
| Li₂O | 10-11 |
| Na₂O | 4.0-5.5 |
| K₂O | 0.27-0.57 |
| CaO | 1.0-3.0 |
| MgO | 0 |
| SnO₂ | 0.1-0.2 |
| ZrO₂ | 0.17-0.3 |
| Fe₂O₃ | 0.001-0.9 |
| Au (ppm) | 3-4.7 |
| Ag (ppm) | 200-930 |
| Anneal Point (° C.) | 550 |
| Strain Point (° C.) | 509 |
| Softening Point (° C.) | 767.4 |
| CTE × 10⁻⁷/° C. | 67.7 |
| Density (g/cm³) | 2.404 |

Referring now to FIG. 6, glass articles formed from example glass composition 17 including about 900 ppm Ag and varying amounts of Au from 0 ppm to 5 ppm are shown. The glass articles were subjected to a heat treatment including heating the glass article from room temperature to 580° C. at a heating rate of 4° C./min, holding the glass articles at the 580° C. for 6 hours, then cooling the glass article to room temperature. As shown, color started to be visibly observable as the Au concentration increased to 1.4 ppm. As exemplified by FIG. 6, the presence of Au, in combination with Ag, helps to achieve yellow glass articles (i.e., glass articles having a b* greater than or equal to 15).

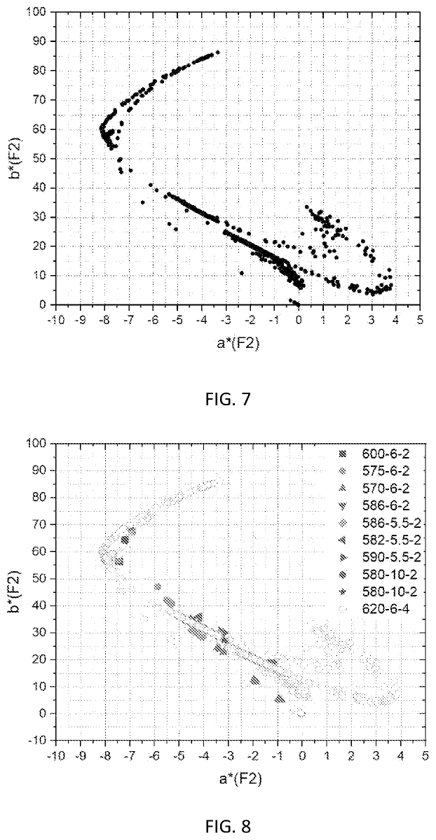

Referring now to FIG. 7 and Table VII, the CIELAB color space achieved by subjecting 2.4 mm thick glass articles formed from example glass composition 17 to heat treatment is listed and shown. The heat treatment included heating the glass article from room temperature to 620° C. at a heating rate of 4° C./min, holding the glass articles at 620° C. for 6 hours, then cooling the glass article to room temperature. Referring now to FIG. 8, the CIELAB color space achieved by subjecting glass articles formed from glass composition 17 to different heat treatments as indicated in the figure (“temperature”-“duration”-“heating rate”) is shown. As exemplified by FIGS. 7 and 8 and Table VII, the glass compositions described herein having a combination of Au and Ag may be subjected to various heat treatments to achieve yellow glass articles (i.e., glass articles having a b* greater than or equal to 15).

TABLE VII

| L* | a* | b* |
|---|---|---|
| 87.33-96.97 | −8.2-3.79 | 0-86.32 |

Referring now to Table VIII, glass articles 17-1 to 17-14 formed from glass composition 17 were subjected to a heat treatment at the temperature and for the time listed. As exemplified by Table VIII, the glass compositions described herein have color stability such that the color sensitivity may be less than 1 b* unit/° C.

TABLE VIII

| Glass | Thickness | Temp. | Time | | | |
|---|---|---|---|---|---|---|
| Article | (mm) | (° C.) | (hr) | L* | a* | b* |
| 17-1 | 2.407 | 620 | 6 | 94.91 | −3.48 | 27.23 |
| 17-2 | 2.403 | 620 | 6 | 94.97 | −3.22 | 25.93 |
| 17-3 | 2.403 | 620 | 6 | 94.89 | −4.05 | 29.57 |
| 17-4 | 2.396 | 620 | 6 | 95.04 | −2.54 | 22.6 |
| 17-5 | 2.396 | 620 | 6 | 95.09 | −2.38 | 21.66 |
| 17-6 | 2.396 | 620 | 6 | 95.12 | −2.25 | 20.97 |
| 17-7 | 2.402 | 623 | 6 | 95.06 | −2.57 | 22.72 |
| 17-8 | 2.395 | 623 | 6 | 95.1 | −2.43 | 21.9 |
| 17-9 | 2.397 | 620 | 6.25 | 95.04 | −2.91 | 24.25 |
| 17-10 | 2.402 | 620 | 6.25 | 95.08 | −2.67 | 23 |
| 17-11 | 2.404 | 617 | 6 | 94.9 | −3.44 | 27.07 |
| 17-12 | 2.397 | 617 | 6 | 94.93 | −3.18 | 25.79 |
| 17-13 | 2.393 | 620 | 5.75 | 94.95 | −3.08 | 25.4 |
| 17-14 | 2.416 | 620 | 5.75 | 94.95 | −2.9 | 24.64 |

Referring now to Table IX, the heat treated glass articles 17-1 to 17-14 listed in Table VIII were exposed to ultraviolet light for 16 minutes and 24 hours as shown in Table IX. As indicated, the glass articles had a small shift in the CIELAB color space, including b*. As exemplified by Table IX, the glass compositions described herein may be used to form glass articles that are UV stable as indicated by a relatively small b* shift.

TABLE IX

| Time | Delta L* | Delta a* | Delta b* |
|---|---|---|---|
| 16 minutes | −0.2-0.5 | 0.1-0.3 | 0.3-0.5 |
| 24 hours | −0.2-0.4 | 0.2-0.3 | −0.3-0.1 |

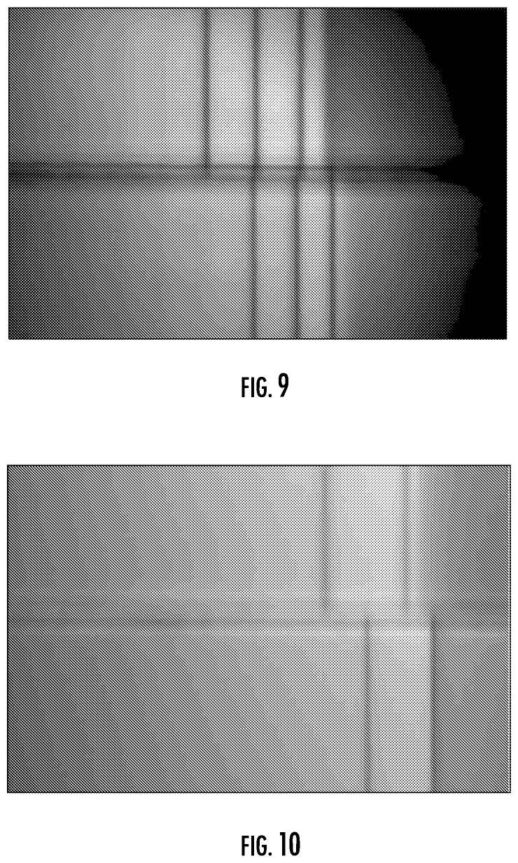

Referring now to FIGS. 9 and 10, a 1.0 mm thick glass article formed from example glass composition 17 was ion exchanged in an ion exchange bath of 16 wt % NaNO₃, 83 wt % KNO₃, and 1 wt % LiNO₃ at 430° C. for 5 hours. FIG. 9 shows an FSM measurement at 365 nm and FIG. 10 shows an FSM measurement at 640 nm. Both images show clear fringes and transition areas.

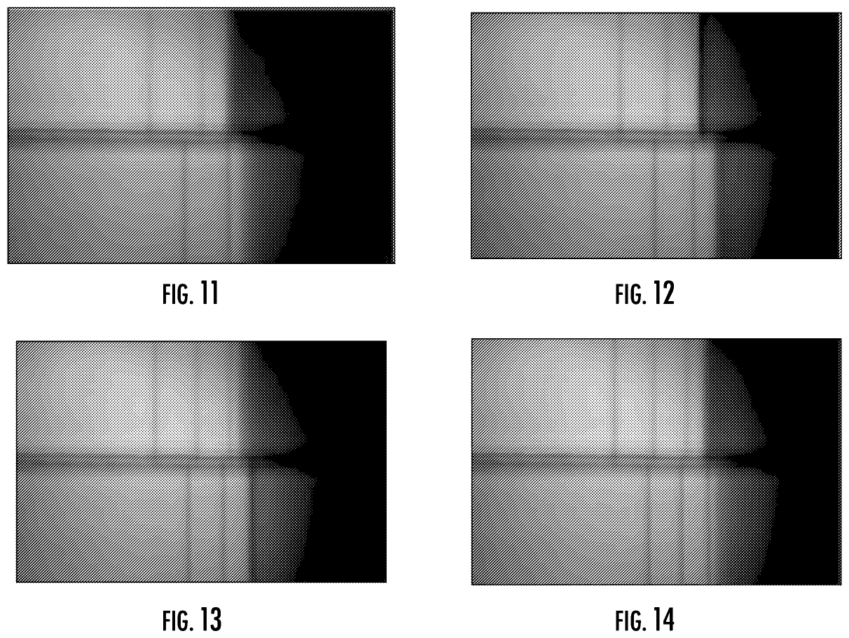

Referring now to FIGS. 11-14 and Table X, 0.55 mm thick glass articles 17-15 to 17-18 formed from example glass composition 17 were ion exchanged in an ion exchange bath of 17 wt % NaNO₃, 82.2 wt % KNO₃, and 0.8 wt % LiNO₃ at 420° C. for 3 hours (FIG. 11), 4 hours (FIG. 12), 5 hours (FIG. 13), and 6 hours (FIG. 14) as indicated in Table X. As exemplified by FIGS. 9-14 and Table X, the glass compositions described herein including Au and Ag may be used to form ion exchangeable glass articles.

TABLE X

| Glass Article | Time (hr) | CS (MPa) | DOC (μm) | CT (MPa) |
|---|---|---|---|---|
| 17-15 | 3 | 727.0 | 110.9 | 96.2 |
| 17-16 | 4 | 713.1 | 111.0 | 100.8 |
| 17-17 | 5 | 691.0 | 108.8 | 101.5 |
| 17-18 | 6 | 674.7 | 110.8 | 98.7 |

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1-28. (canceled)

29. A glass composition, comprising:
greater than or equal to 55 mol % to less than or equal to 76 mol % SiO₂;
greater than or equal to 8 mol % to less than or equal to 18 mol % Al₂O₃;
greater than or equal to 0.1 mol % to less than or equal to 10 mol % Na₂O;
greater than 0 mol % to less than or equal to 4 mol % K₂O;
greater than 0 mol % to less than or equal to 3 mol % ZrO₂;
greater than 0 ppm to less than or equal to 30 ppm Au; and
greater than 0 ppm to less than or equal to 2000 ppm Ag.

30. The glass composition of claim 29, comprising greater than or equal to 0.5 ppm to less than or equal to 20 ppm Au.

31. The glass composition of claim 29, comprising greater than or equal to 50 ppm to less than or equal to 1500 ppm Ag.

32. The glass composition of claim 29, comprising greater than 0 mol % to less than or equal to 10 mol % B₂O₃.

33. The glass composition of claim 29, further comprising:
greater than or equal to 1 mol % to less than or equal to 9 mol % Na₂O;
greater than or equal to 0.1 mol % to less than or equal to 3 mol % K₂O; and
greater than 0 mol % to less than or equal to 20 mol % Li₂O.

34-35. (canceled)

36. The glass composition of claim 29, wherein the Al₂O₃ is greater than or equal to 9 mol % to less than or equal to 17 mol %.

37. The glass composition of claim 29, further comprising greater than 0 mol % to less than or equal to 8 mol % MgO.

38-39. (canceled)

40. The glass composition of claim 29, further comprising greater than 0 mol % to less than or equal to 6 mol % CaO.

41-45. (canceled)

46. The glass composition of claim 29, further comprising greater than 0 mol % and less than or equal to 1 mol % TiO₂.

47-49. (canceled)

50. A colored glass-based article, comprising:
greater than 0 ppm to less than or equal to 30 ppm Au; and
greater than 0 ppm to less than or equal to 2000 ppm Ag,
wherein the colored glass-based article has a transmittance color coordinate in the CIELAB color space, as measured under F2 illumination and a 10° standard observer angle, of:
L* greater than or equal to 50 and less than or equal to 98;
a* greater than or equal to −5 and less than or equal to 20; and
b* greater than or equal to 15 and less than or equal to 105.

51. The colored-glass based article of claim 50, wherein the colored glass-based article has a transmittance color coordinate in the CIELAB color space, as measured under F2 illumination and a 100 standard observer angle, of b* greater than or equal to 25 and less than or equal to 100.

52. The colored-glass based article of claim 50, wherein the colored glass-based article has a transmittance color coordinate in the CIELAB color space, as measured under F2 illumination and a 10° standard observer angle, of a* greater than or equal to −3 and less than or equal to 15.

53. The colored-glass based article of claim 50, wherein the colored glass-based article has a transmittance color coordinate in the CIELAB color space, as measured under F2 illumination and a 100 standard observer angle, of L* greater than or equal to 52 and less than or equal to 96.

54. The colored glass-based article of claim 50, wherein the colored glass-based article has a delta b* value of less than 1 b* unit/° C.

55. The colored glass-based article of claim 50, wherein the colored glass-based articles has a delta b* transmittance color coordinate in the CIELAB color space, as measured under F2 illumination and a 100 standard observer angle, of greater than or equal to −1 and less than or equal to 1, when exposed to ultraviolet light for 24 hours.

56-62. (canceled)

63. A consumer electronic device, comprising:
a housing having a front surface, a back surface, and side surfaces; and
electrical components provided at least partially within the housing, the electrical components including at least a controller, a memory, and a display, the display being provided at or adjacent the front surface of the housing;
wherein the housing comprises the glass-based article of claim 50.

64. A method of forming a glass-based article, comprising:
heating a glass composition to form a glass-based article, the glass composition comprising:
greater than or equal to 55 mol % to less than or equal to 76 mol % SiO₂;
greater than or equal to 8 mol % to less than or equal to 18 mol % Al₂O₃;
greater than or equal to 0.1 mol % to less than or equal to 10 mol % Na₂O;
greater than 0 mol % to less than or equal to 4 mol % K₂O;
greater than 0 mol % to less than or equal to 3 mol % ZrO₂;
greater than 0 ppm to less than or equal to 30 ppm Au; and
greater than 0 ppm to less than or equal to 2000 ppm Ag; and
subjecting the glass-based article to a heat treatment cycle at a temperature greater than or equal to 500° C. and less than or equal to 800° C. for a duration greater than or equal to 0.25 hour and less than or equal to 24 hours to produce a colored glass-based article.

65. The method of claim 64, wherein the heat treatment cycle comprises heating the glass-based article from room temperature to the temperature at a heating rate of 1° C./min to 10° C./min.

66. The method of claim 64, comprising strengthening the glass-based article in an ion exchange bath at a temperature greater than or equal to 350° C. to less than or equal to 500° C. for a time period greater than or equal to 2 hours to less than or equal to 12 hours to form an ion exchanged glass-based article.
